(19) United States
(12) Patent Application Publication
(10) Pub. No.: US 2020/0230795 A1
(43) Pub. Date: Jul. 23, 2020

(54) Multi-Stroke Powered Safety Hammer System

(71) Applicant: Donald W. Carlson, Scottsdale, AZ (US)

(72) Inventors: Donald W. Carlson, Scottsdale, AZ (US); Donald Perron, North Smithfield, RI (US); Prudencio S. Canlas, JR., North Kingstown, RI (US)

(73) Assignee: Donald W. Carlson, Scottsdale, AZ (US)

(21) Appl. No.: 16/745,926

(22) Filed: Jan. 17, 2020

Related U.S. Application Data
(60) Provisional application No. 62/793,811, filed on Jan. 17, 2019.

(51) Int. Cl. B25F 3/00; B25C 1/04; B25C 1/00; B25D 9/04; B25C 7/00; B25D 17/02; B25C 11/00

(52) U.S. Cl. CPC B25F 3/00; B25C 1/047; B25C 1/008; B25D 9/04; B25D 2250/331; B25D 17/02; B25D 2250/111; B25C 11/00; B25C 7/00

(57) ABSTRACT

A multi-stroke powered safety hammer system includes a hammer having a body, a cylinder within the body, and a piston carried in the cylinder for reciprocal movement therein. The system includes a quick-connect coupling mount on the hammer, the mount having an inner barrel bounding a hollow interior, an outer sleeve for sliding movement over the inner barrel, and an engagement assembly defined by the inner barrel and the outer sleeve for locking an attachment in the interior. The system includes one of many attachments with an engagement portion; when the engagement portion is applied to the quick-connect coupling mount and the hammer is operated, the piston reciprocates to impact the engagement portion. The attachments guide fasteners, remove fasteners, and process materials.

### CROSS-REFERENCE TO RELATED APPLICATIONS

This application claims the benefit of U.S. Provisional Application No. 62/793,811, filed Jan. 17, 2019, which is hereby incorporated by reference.

### FIELD

The present specification relates generally to tools, and more particularly to hammering, nailing, stapling, pounding, and other powered impact tools used for material processing.

### BACKGROUND

The advent of powered tools ushered productivity and efficiency into the construction and similar product processing industries. Workers using powered tools such as nail and staple guns, drills, saws, and screwdrivers became able to work faster, more efficiently, and with greater accuracy than their counterparts equipped with manually-operated tools.

Many of these tools required fasteners to be linked together, or collated. Powered nail and staple guns using dedicated collated fasteners are limited in their ability to drive individual fasteners, however. These tools cannot handle the myriad of hand-held and hand-driven nails, staples, and similar singleton fasteners which must instead be driven by manual hammers.

Currently-available tools cannot always be efficiently used in all situations. Frequently, the design of houses and similar structures and assemblies dictates the need to properly, precisely, and effectively install fasteners where there is limited, confined, or remote access. By the nature of their configuration, both powered nail and staple guns, and also manual hammers, present substantial difficulties of use in such locations. Manual hammers, for instance, can be difficult to swing in awkward spaces, like upside down under a truss.

Manual tools also expose their users to musculoskeletal injuries. The constant and repetitive gripping, swinging, and pounding of a hammer, for instance, presents a risk of carpal tunnel syndrome, tendonitis, carpenter's elbow, rotator cuff damage, and similar ailments. And, of course, fingers and thumbs are always being smashed and broken.

Moreover, manual tools are not necessarily sufficiently precise to guarantee consistency. Building and national standardized codes set standards for driving fasteners, such as the manner, depth, and other characteristics. Materials and fastener manufacturers additionally recommend or even warrant similar characteristics, while making no claim or promise regarding fasteners driven in another way. Manual tools used in the best of circumstances cannot reliably drive nails, staples, pins, and other fasteners consistently to ensure that codes, standards, and recommendations are always met. Manual tools used in more real-world circumstances—such as by a worker with arthritis, who has been holding the tool for several hours already, who might be hammering upside, or is using the tool in a confined space—are even less reliable.

For all of these reasons, an improved powered tool is needed which provides proper, precise, reliable, consistent, and safe driving of single fasteners.

### SUMMARY

The multi-stroke powered safety hammer system described herein is a safer, healthier alternative to manual hammers, reducing workers' exposure to musculoskeletal injuries. It allows workers to drive a wide range of hand-held nails, staples, spikes, and other fasteners faster, more effectively, and efficiently than manual hammers. Further, workers can easily change the processing mode of the hammer system between one of many various powered fastener applicators, fastener extractors, and punches, as well as processing tools such as chisels, scrapers, chippers, and similar tools for materials preparation, deconstruction, salvage, and demolition. Workers can also apply specialty pounding and shaping attachments such as hard, soft, flat, or curved hammering heads.

A multi-stroke powered safety hammer system includes a hammer having a body, a cylinder within the body, and a piston carried in the cylinder for reciprocal movement therein. The system includes a quick-connect coupling mount on the hammer, the mount having an inner barrel bounding a hollow interior, an outer sleeve for sliding movement over the inner barrel, and an engagement assembly defined by the inner barrel and the outer sleeve for locking an attachment in the interior. The system includes one of many attachments with an engagement portion; when the engagement portion is applied to the quick-connect coupling mount and the hammer is operated, the piston reciprocates to impact the engagement portion. The attachments guide fasteners, remove fasteners, and process materials.

The above provides the reader with a very brief summary of some embodiments described below. Simplifications and omissions are made, and the summary is not intended to limit or define in any way the disclosure. Rather, this brief summary merely introduces the reader to some aspects of some embodiments in preparation for the detailed description that follows.

### BRIEF DESCRIPTION OF THE DRAWINGS

Referring to the drawings:

FIGS. 1A, 1B, and 1C are top, bottom, and exploded perspective views, respectively, of a multi-stroke powered safety hammer system including a hammer, a quick-coupling mount, and a nosepiece attachment;

FIGS. 1D and 1E are section views taken along the line 1-1 in FIG. 1A, showing a piston within the hammer in advanced and retracted positions, respectively;

FIG. 1F is a section view taken along the line 1-1 in FIG. 1A showing the piston moving toward the advanced position, impacting a driver of the nosepiece attachment;

FIG. 1G is a section view taken along the line 1-1 in FIG. 1A showing the piston in the advanced position, and the driver of the nosepiece attachment moving forward;

FIG. 1H is a section view taken along the line 1-1 in FIG. 1A showing the quick-coupling mount in an unlocked condition and the nosepiece attachment being removed therefrom;

FIG. 2A is a perspective view of the nosepiece of FIG. 1A;

FIGS. 2B and 2C are section views taken along the line 2-2 in FIG. 2A, showing the nosepiece in extended and retracted positions, respectively;

FIG. 3A is a perspective view of a nosepiece attachment for use with the hammer;

FIGS. 3B and 3C are section views taken along the line 3-3 in FIG. 3A, showing the nosepiece in extended and retracted positions, respectively;

FIG. 4A is a perspective view of a nosepiece attachment for use with the hammer;

FIGS. 4B and 4C are section views taken along the line 4-4 in FIG. 4A, showing the nosepiece in extended and retracted positions, respectively;

FIG. 5 is a perspective view of a processing tool for use with the hammer;

FIG. 6 is a perspective view of a processing tool for use with the hammer;

FIG. 7 is a perspective view of a fencing stapler remover for use with the hammer;

FIG. 8A is a perspective view of a de-nailer attachment for use with the hammer;

FIG. 8B is a section view taken of the de-nailer along the line 8-8 in FIG. 8A;

FIG. 9A is a perspective view of a de-stapler attachment for use with the hammer;

FIG. 9B is a section view taken of the de-stapler along the line 9-9 in FIG. 9A;

FIG. 10 is a perspective view of a conical processing tool for use with the hammer;

FIG. 11 is a perspective view of a wide scraping attachment for use with the hammer;

FIG. 12 is a perspective view of a chiseling tool for use with the hammer;

FIG. 13 is a perspective view of a chipping tool for use with the hammer;

FIG. 14A is a perspective view of a soft hammer head and shank for use with the hammer;

FIG. 14B is a section view taken of the soft hammer head and shank along the line 14-14 in FIG. 14A;

FIG. 15A is a perspective view of a convex hammer head and shank for use with the hammer;

FIG. 15B is a section view taken of the convex hammer head and shank along the line 15-15 in FIG. 15A;

FIG. 16A is a perspective view of a flat hammer head and shank for use with the hammer; and

FIG. 16B is a section view taken of the flat hammer head and shank along the line 16-16 in FIG. 16A.

### DETAILED DESCRIPTION

Reference now is made to the drawings, in which the same reference characters are used throughout the different figures to designate the same elements. Briefly, the embodiments presented herein are preferred exemplary embodiments and are not intended to limit the scope, applicability, or configuration of all possible embodiments, but rather to provide an enabling description for all possible embodiments within the scope and spirit of the specification. Description of these preferred embodiments is generally made with the use of verbs such as “is” and “are” rather than “may,” “could,” “includes,” “comprises,” and the like, because the description is made with reference to the drawings presented. One having ordinary skill in the art will understand that changes may be made in the structure, arrangement, number, and function of elements and features without departing from the scope and spirit of the specification. Further, the description may omit certain information which is readily known to one having ordinary skill in the art to prevent crowding the description with detail which is not necessary for enablement. Indeed, the diction used herein is meant to be readable and informational rather than to delineate and limit the specification; therefore, the scope and spirit of the specification should not be limited by the following description and its language choices.

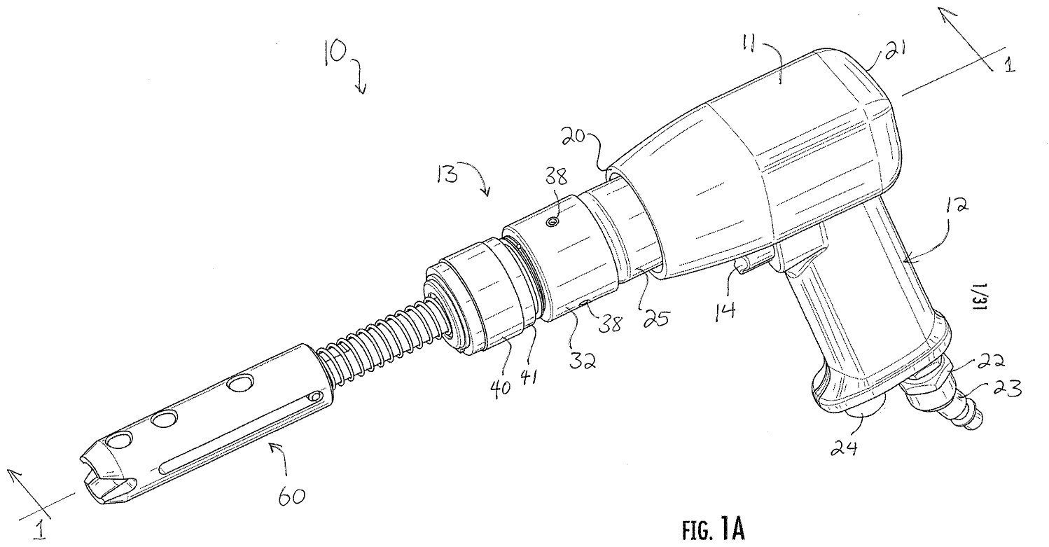

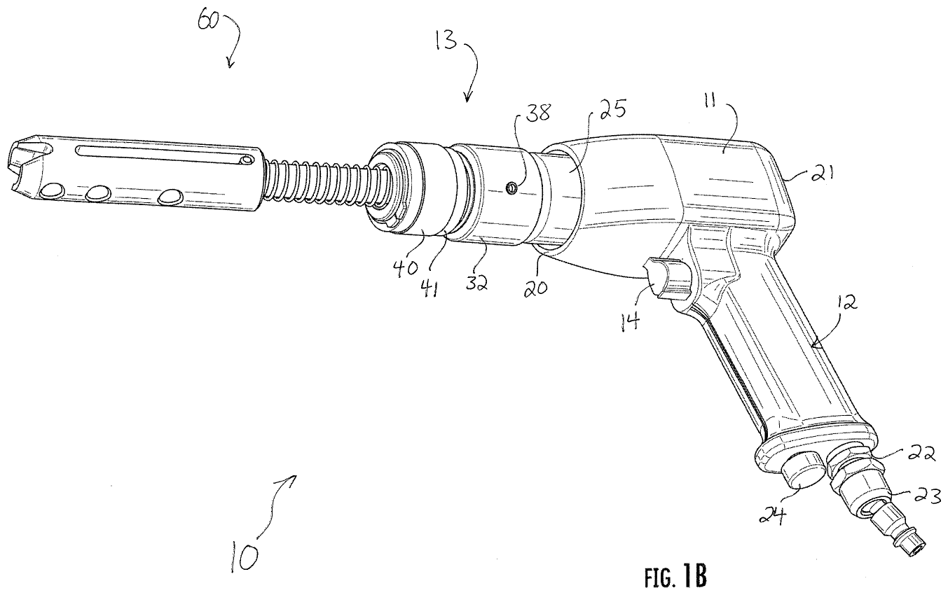

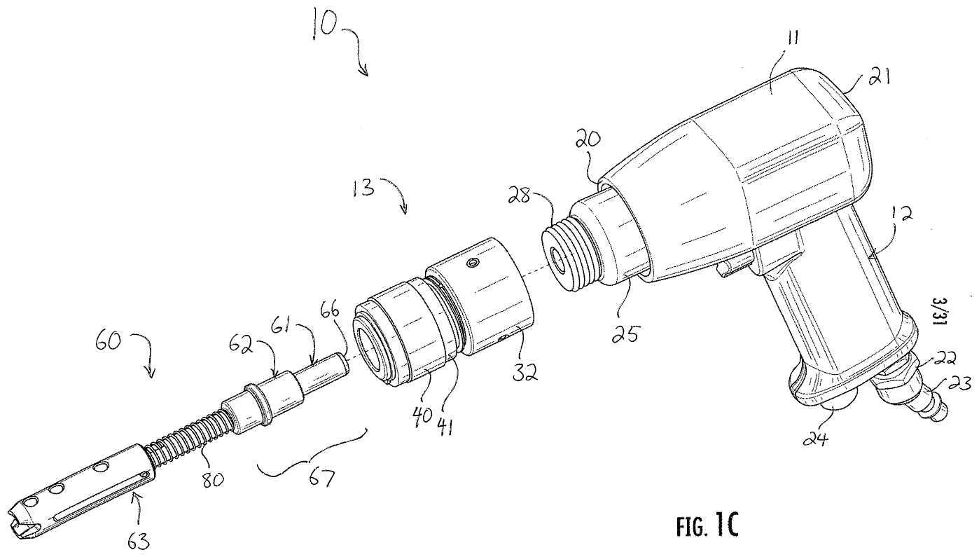

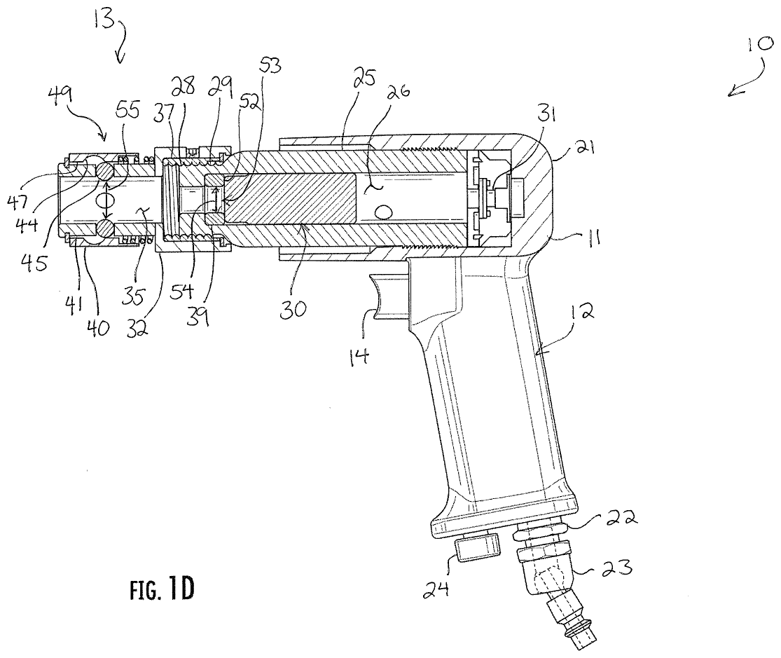

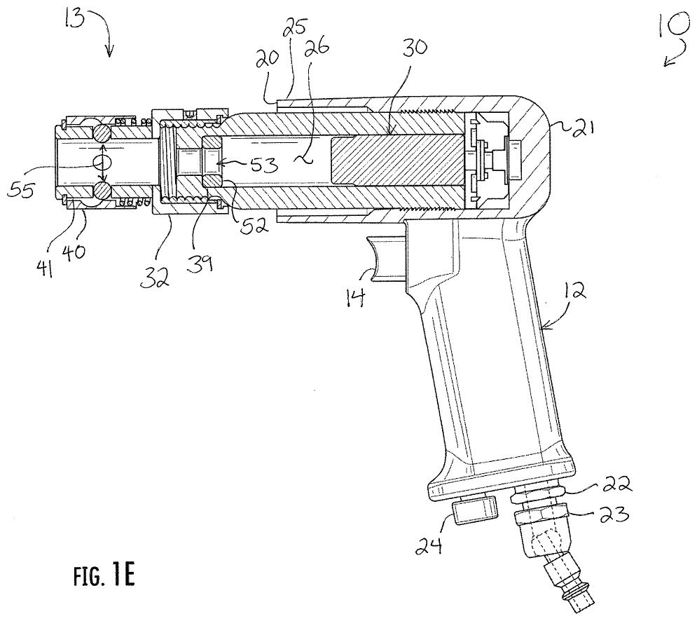

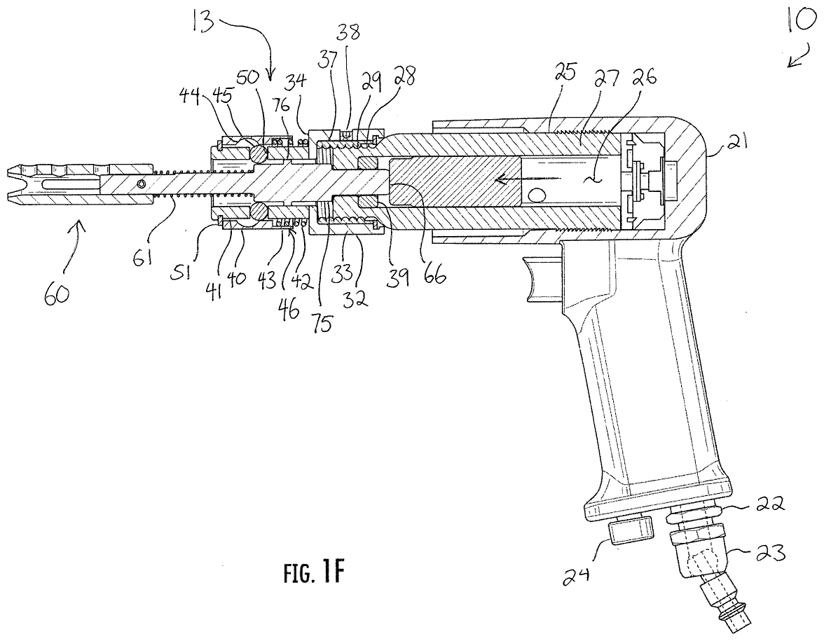

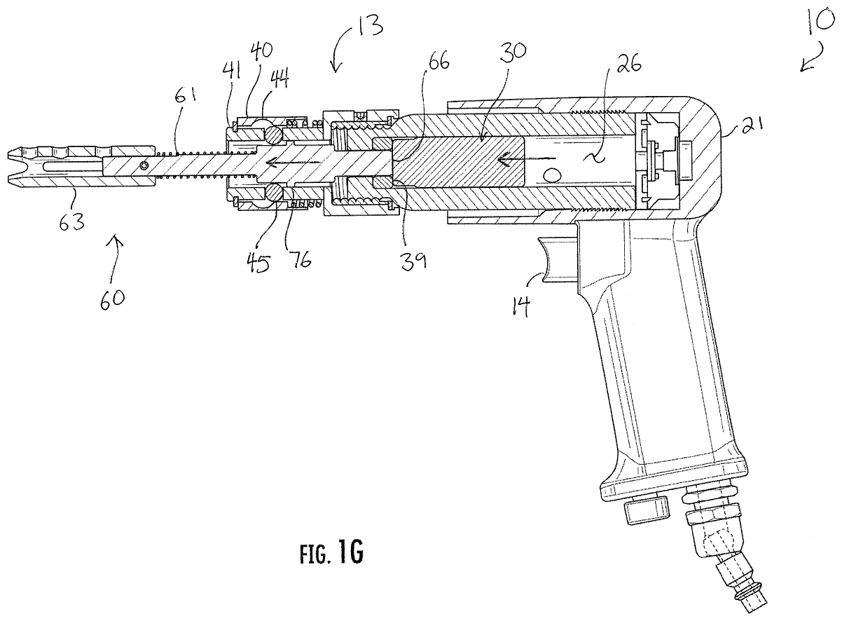

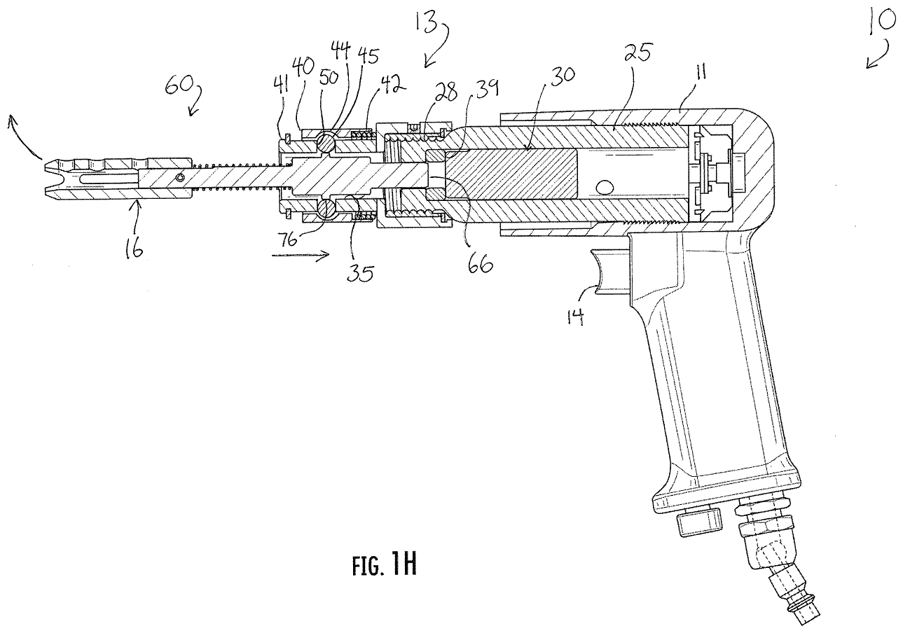

FIGS. 1A-1H illustrate a multi-stroke powered safety hammer 10 (hereinafter, the “hammer 10”) including a body 11, a handle 12 formed integrally and monolithically to the body 11, and a quick-connect coupling mount 13 (hereinafter, the “mount 13”). A variety of removable attachments 16, such as nail guides, nosepieces, fixed implements, processing tools, and the like, shown in the remaining drawings, are applicable to the mount 13 of the hammer 10 to convert the hammer 10 into a variety of special-purpose powered processing hammer tools. Each is an attachment 16, but each is given a unique name and reference character for clarity.

Indeed, in FIGS. 1A-1C and 1F-1H, the hammer 10 is fit with one such attachment 16, identified as a nosepiece 60, which is suitable for driving nails of approximately 3½ inches in length. Single nails, spikes, staples, and other fasteners are loaded into some of these nosepieces for driving by a cyclical, reciprocal, multi-stroke hammering action. Other of the attachments 16 are processing bits or fixed implements and are applied to the hammer 10 to work a surface, such as by chiseling along a surface, boring out a hole, or punching a nail through a piece of lumber. Pneumatic and mechanical parts within the body 11 operate to cycle a moveable piston through the body 11 and into the selected nosepiece fit onto the hammer. A trigger 14 activates operation of the hammer 10 in the worker's hand.

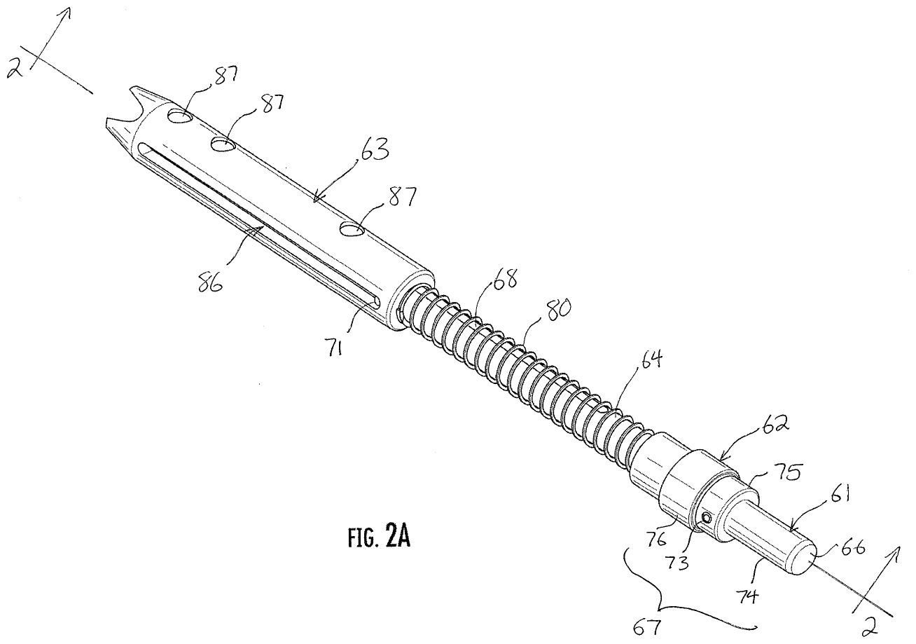

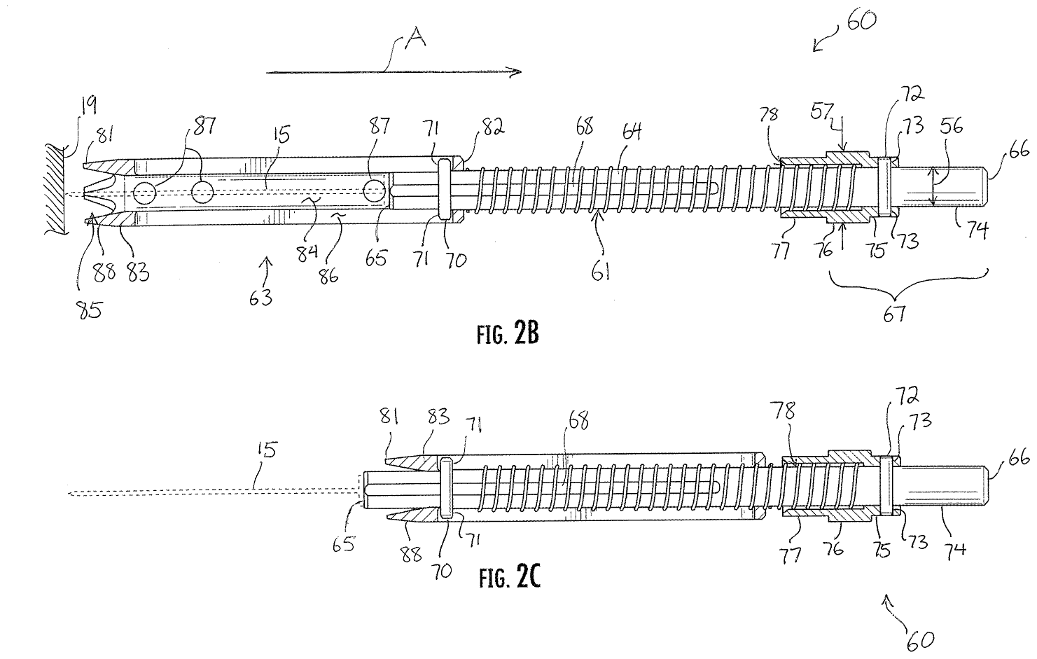

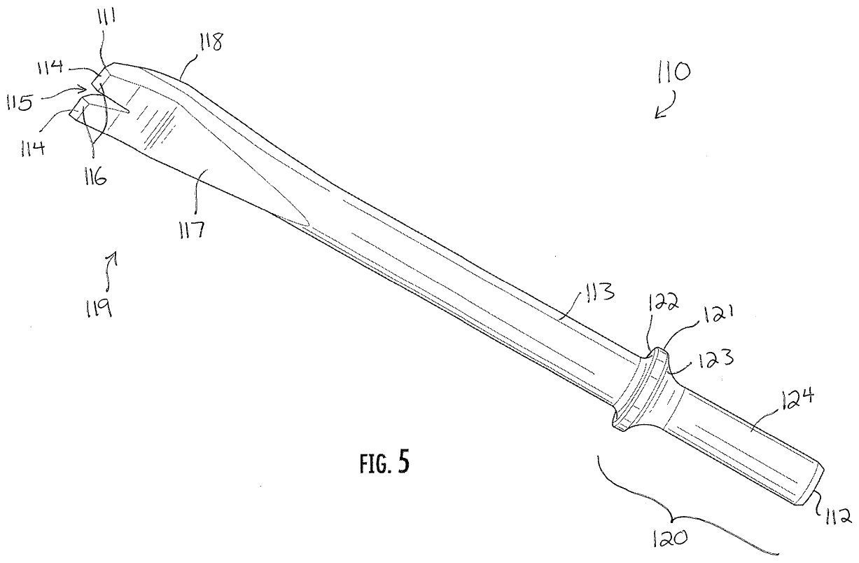

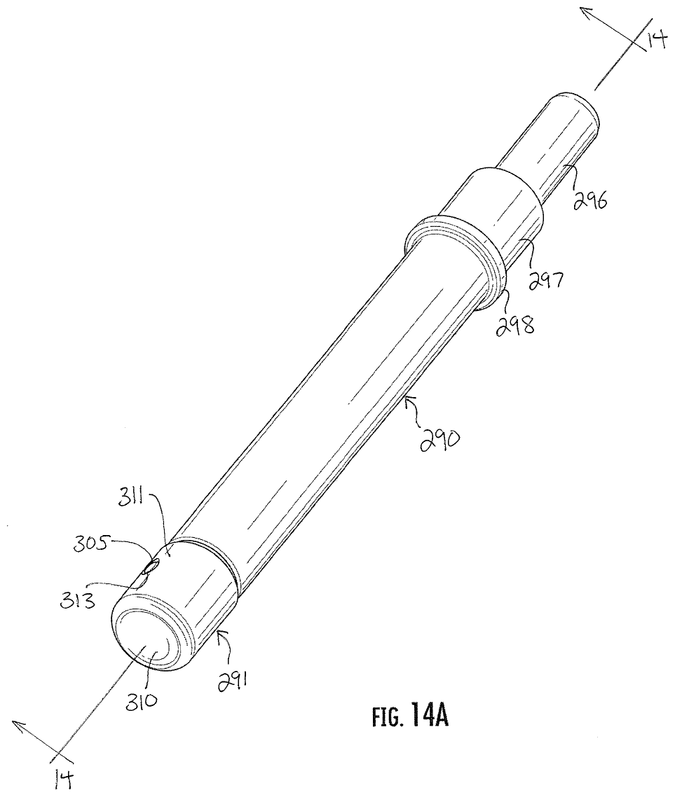

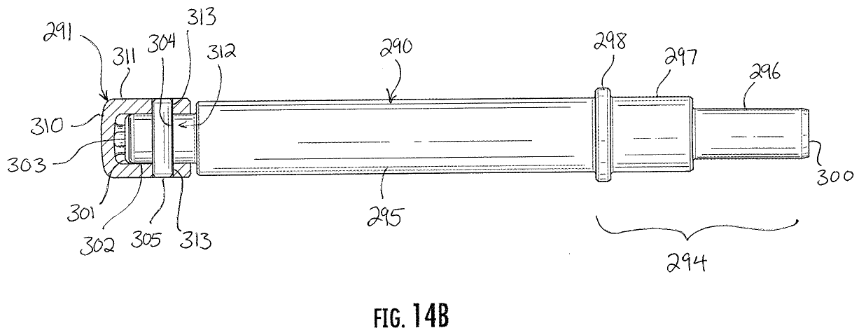

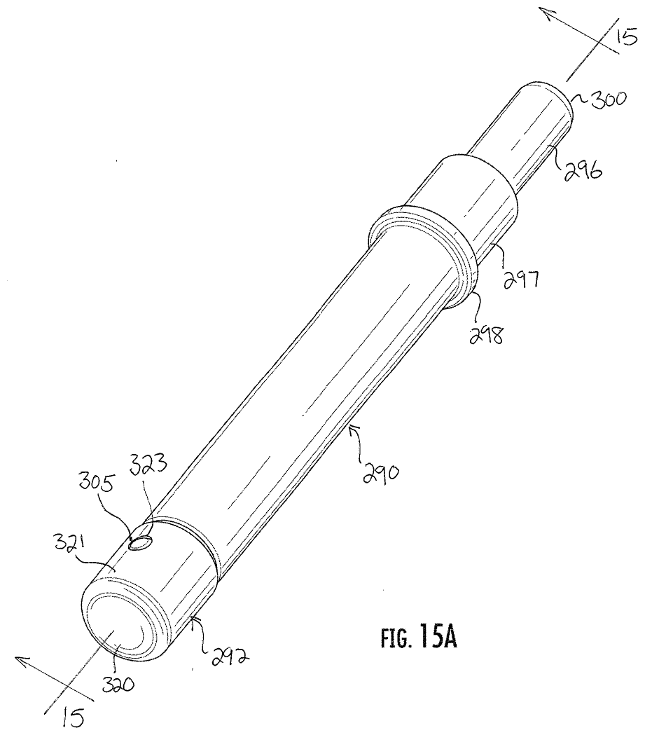

FIGS. 2A-16B illustrate some of the various attachments. Those of FIGS. 2A-4C are guides for holding and driving fasteners, while those of FIGS. 5-13 are processing tools, and FIGS. 14A-16B show various types of hammering heads for different applications. Each is described in detail below.

FIGS. 1A and 1B are top and bottom front perspective views of the hammer 10 with the nosepiece 60, FIG. 1C is an exploded view of the hammer 10 and nosepiece 60, and FIGS. 1D-1F are partial section views of the hammer 10 taken along the line 1-1 in FIG. 1A. The description of the hammer 10 is made herein with respect to the FIGS. 1A-1H. FIGS. 1F-1H are section views showing the nosepiece 60 applied to the hammer 10, but do not show all of the structural elements and features of the nosepiece 60 for simplicity. The body 11 of the hammer 10 is a large hollow housing, constructed from a molded sidewall of very hard, rigid, rugged, and durable material or combination of materials, such as high-density plastic or metal. The body 11 surrounds and protects the internal componentry of the hammer 10 and provides mounting locations for such componentry.

The body 11 extends from a front end 20 to an opposed rear end 21. A cylinder 25 is engaged within the body 11 and projects out of the front end 20. The rear of the cylinder 25 has outwardly-directed threads which threadably engage with internally-directed threads inside the body 11 to hold the cylinder 25 in place within the body 11. The cylinder 25 bounds and defines a cylindrical interior 26 of the hammer 10 in which a piston 30 reciprocates between an advanced position toward the front end 20 (as shown in FIG. 1D) and a retracted position toward the rear end (as shown in FIG. 1E). The interior 26 is substantially enclosed; the body 11 encloses the rear end of the interior 26, the cylinder 25 encircles the interior 26, and the mount 13 is secured to the front of the cylinder 25. While the mount 13 is open, it is usually fit with an attachment 16 which encloses the front of the interior 26.

Below the body 11, and formed integrally and monolithically as part of the same sidewall forming the body 11, the handle 12 extends downward and provides a location at which a worker can grab and hold the hammer 10. The handle 12 is a slender extension of the body 11. It is, like the body 11 to which it is formed, constructed from a hard, rigid, rugged, and durable material or combination of materials, such as high-density plastic or metal. The handle 12 extends from a top to an opposed bottom. A slot through the body 11 is formed at the top, and the trigger is disposed in this slot. The handle 12 is generally thin between the top and the bottom, and flares outwardly at the bottom. An end cap 22 is affixed to the bottom, where a pneumatic coupling is located and available to receive a pneumatic hose. A pneumatic adjuster 24 is proximate the end cap 22 and adjustable to set the flow rater of gas through the end cap 22.

Preferably, and though not shown in these drawings, most of the length of the handle 12 is covered by an anti-shock cushioned grip. The grip is a sleeve fit over the handle 12 to provide the worker with cushion when operating the hammer 10 to reduce transmission of vibration and impact forces from the hammer 10 to the worker.

The trigger 14 is disposed in the slot in front of the handle 12 to be depressed by an index finger of the worker. Depression of the trigger 14 causes the hammer 10 to operate. When the trigger 14 is depressed, compressed gas, preferably supplied by a pneumatic hose connected to the pneumatic coupling 23 and extending from a compressor or other source, is routed into the componentry within the body 11. The compressed gas is passed into the interior 26 behind the piston 30 carried therein. The piston 30 is mounted for reciprocal movement within the cylinder 25. A port 31 at the back of the cylinder 25 communicates the supplied compressed gas behind the piston 30, and the piston 30 quickly moves forward as the interior 26 behind the piston 30 fills with gas. As the piston 30 moves forward, that gas is vented, and then a port at the front end of the cylinder 25 communicates supplied compressed gas in front of the piston 30. This causes the piston 30 to move quickly backward as the interior 26 in front of the piston 30 fills with gas. Gas is rapidly cycled between these two ports, causing the piston 30 to rapidly reciprocate between the advanced and retracted positions. The cylinder 25 has a larger bore than is typical of other pneumatic tools. Whereas conventional tools have a 0.750 inch bore, the bore of the cylinder 25 is preferably, but not necessarily, 0.814 inches. This larger bore provides greater energy per stroke length, resulting in more powerful and faster hammering. It should be understood that the bore dimension of 0.814 inches, though preferable, is by no means intended to be limiting to this disclosure, and the cylinder 25 may have other dimensions while remaining operable and suitable for the function of the hammer 10.

A bumper 39 is carried within the cylinder 25. The bumper 39 is disposed at the front of the cylinder 25, in front of the piston 30 and thus between the piston 30 and the cylinder 25. The bumper 39 is retained at the front of the piston 30 at all times while the piston 30 reciprocates. The bumper 39 includes an annular body 52 and a central bore 53 formed therein. The body 52 has an outer diameter that is equal to the inner diameter of the cylinder 25, such that the body 52 is snugly fit within the cylinder 25 at the front end thereof. The bore 53 is coaxial to and registered with the piston 30 and the hollow interior 35 of the mount 13. Indeed, the bumper 39 is actually disposed within the interior 35 because it is carried in the neck 28 of the cylinder 25 encircled by the rear collar 32 of the mount 13. Moreover, the bumper 39 has an inner diameter 54 which corresponds to the inner diameter of the front end of the neck 28. In this way, when an attachment 16 is applied to the mount 13, an engagement portion of the attachment 16, at the rear end of the attachment 16, is inserted and closely received both by the inner diameter of the front of the neck 28 and by the inner diameter 54 of the bumper 39. The bumper 39 has elastomeric, resilient, shock-absorbing material characteristics. The bumper 39 softens the impact of the piston 30 when the piston 30 moves forwardly and also provides a resilient, rebound force rearward on the piston 30 toward the rear end 21 of the body 10.

Referring now to FIG. 1F, when an attachment 16 such as the nosepiece 60 is fit into the mount 13, and the hammer 10 is operated, the reciprocating piston 30 repeatedly slams into the back of the attachment 16. And when a fastener is held in the nosepiece 60, this action hammers the fastener into the working surface until the fastener is sunk therein. Some attachments 16 incorporate reciprocating drivers. In attachments 16 that hammer fasteners—such as the nosepiece 60—the driver is carried within the attachment 16, the piston 30 hits the driver, and the driver hits the fastener. In other attachments 16, such as processing bits or tools of some of the later drawings, there may be no driver and the attachment 16 is instead a single piece, such that the piston hammers the rear end of the attachment 16 itself and so the entire attachment 16 is hammered.

The attachments 16 are all fit into the mount 13, which is an interface and engagement secured on the cylinder 25. The cylinder 25 has a cylindrical sidewall 27 which extends forwardly past the front end 20 of the body 11. Beyond the front end 20, the sidewall 27 constricts to a neck 28. The neck 28 is formed with externally-directed threads 29. A cylindrical plastic sleeve 37 has complemental internally-directed full-radius threads, and the sleeve 37 is threadably engaged onto the neck. The mount 13 is fixed to the sleeve 37 to secure the mount 13 on the cylinder 25.

The mount 13 includes an inner barrel 41 formed to a rear collar 32, and an outer sleeve 40 over the inner barrel 41. The inner barrel 41 and rear collar 32 form a one-piece cylindrical body. The larger-diameter rear collar 32 fits over the neck 28 of the cylinder 25, and the reduced-diameter inner barrel 41 projects axially in front of that collar 32. The outer sleeve 40 is a sliding, locking sleeve for securing attachments applied within the mount 13. The collar 32 and inner barrel 41 are coaxial to each other and formed monolithically from the same material or combination of materials.

The collar 32 is secured on and projects forwardly from the neck 28 of the cylinder 25. The mount 13 has a cylindrical sidewall 33, and so, along the collar 32, the sidewall 33 encircles the sleeve 37. Circumferentially spaced-apart bores are formed through the sidewall 33 (one can be seen in FIG. 1F), and set screws 38 are threadably engaged through the bores and into the sleeve 37, thereby fixing the collar 32 on the sleeve 37 and thus also on the cylinder 25. The collar 32 portion of the mount 13 terminates forwardly at a front flange 34. At the front flange 34, the sidewall 33 turns radially inwardly from the collar 32, extends inward to an inner diameter, and then turns back axially forward to form the inner barrel 41 projecting forwardly. The front flange 34 is disposed at and in contact with the sleeve 37 on the front of the neck 28 of the cylinder 25.

The mount 13 bounds a hollow interior 35 which has a larger diameter within the collar 32 (accommodating the neck 28 and the sleeve 37 thereon), but a smaller diameter within the inner barrel 41 in front of the collar 32. This smaller diameter is less than the outer diameter of the neck 28, such that the inner barrel 41—and thus the mount 13—cannot move over the neck 28. The hollow interior 35 is coaxial to the piston 30 and to the interior 26 in which the piston reciprocates. The full length of the hollow interior 35 receives an attachment 16 when it is applied to the mount 13. That attachment 16 extends through the interior 35, partially into the interior 26, is locked in place by the inner barrel 41 and a locking outer sleeve 40 on the inner barrel 41.

The inner barrel 41 is an inner barrel carrying the outer sleeve 40. The outer sleeve 40 moves or slides axially relative to the inner barrel 41 between advanced and retracted positions to arrange the mount 13 in either locked or unlocked conditions, respectively. The mount 13 is biased into the locked condition by a helical compression spring 42 disposed radially between the inner barrel 41 and outer sleeve 40, which biases the outer sleeve 40 forward into an advanced position with respect to the inner barrel 41. The outer sleeve 40 has a front end, a rear end, and an annular sidewall extending therebetween.

An engagement assembly 49 for locking an attachment 16 in the hollow interior 35 of the mount 13 is defined by the outer sleeve 40 and the inner barrel 41. Proximate to the front end of the outer sleeve 40, on an inner surface 47 thereof, partially-spherical depressions 44 extend into the body of the outer sleeve 40 from the inner surface 47 and are circumferentially spaced apart. Opposing these depressions 44, a set of circumferentially spaced-apart holes 50 are formed in and through the sidewall 33 in the inner barrel 41. Ball bearings 45 are carried in the holes 50 in the inner barrel 41 and are moved radially either into or out of these depressions 44 when the mount 13 is moved. Engagement and disengagement of the ball bearings 45 with the depressions 44 in this manner locks and unlocks the mount 13.

The inner surface 47 of the outer sleeve 40 slides smoothly along the outer surface of the inner barrel 41. The rear end of the outer sleeve 40 has a rearwardly-projecting collar 43 which is radially-spaced apart from the inner barrel 41, thereby defining an annular hold 46 at the rear end of the outer sleeve 40. This annular hold 46 captures the front end of the spring 42, with the rear end of the spring 42 against the front flange 34 of the mount 13. The spring 42 is therefore compressed between the outer sleeve 40 and the inner barrel 41, urging the outer sleeve 40 forward, away from the body 11 of the hammer 10. Again, this advanced position of the outer sleeve 40 constitutes a locked condition of the mount 13.

FIGS. 1D, 1E, 1F, and 1G all show the mount 13 in the locked condition. The outer sleeve 40 is slid forward and is prevented from further forward movement by confrontation with an annular ring 51 at the front of the barrel 41. As such, the depressions 44 are axially offset from the holes 50, and so the ball bearings 45 cannot move from the holes 50 into the depression 44. Rather, the ball bearings 45 are retained in the holes 50 in the inner barrel 41. Indeed, in this locked condition of the mount 13, the inner surface 47 of the outer sleeve 40 pushes or urges the ball bearings 45 into the holes 50 and toward the hollow interior 35. And when an attachment 16 is in the mount 13, the ball bearings 45 are pushed into the attachment 16, as shown in FIGS. 1F and 1G. When the outer sleeve 40 is in the advanced position thereof, the ball bearings 45 define a circle within the hollow interior 35 of the mount 13 having an inner diameter 55. A flange on the nosepiece 60 behind the ball bearings 45 has a larger diameter than this inner diameter 55, and this prevents the nosepiece 60 from coming loose from or falling out of the hammer 10.

The mount 13 allows quick change and replacement of different attachments 16. In some embodiments, the outer surface of the outer sleeve 40 is knurled to assist the worker in grasping the outer sleeve 40 when moving it between the advanced and retracted positions with respect to the inner barrel 41.

By moving the outer sleeve 40 backward into the retracted position, an attachment 16 can be released from the mount 13 and can be removed or replaced. FIG. 1H illustrates the outer sleeve 40 in this retraced position, unlocking the mount 13. To move the outer sleeve 40 into the retracted position with respect to the inner barrel 41 and thus place the mount 13 in the unlocked condition, the outer sleeve 40 is grasped by hand and pulled rearwardly, toward the body 11. The inner barrel 41 does not move, and so this relative axial movement of the outer sleeve 40 to the inner barrel 41 radially registers the depressions 44 over the holes 50 and the ball bearings 45 in the holes 50. As such, the retracted position of the outer sleeve 40 allows the ball bearings 45 to slightly displace radially out of the holes 50 and into the depressions 44.

When the ball bearings 45 are moved partially into the depressions 44, the attachment 16 can be removed; the attachment 16 is pulled from the mount with the flange on the attachment 16 clearing the ball bearings 45. This is described in more detail specifically with respect to the nosepiece 60 below.

Once an attachment 16 has been removed, the worker can release the outer sleeve 40. Releasing the outer sleeve 40 causes it to snap forward into the advanced position, moving the ball bearings 45 back into the holes 50, and re-arranging the mount 13 in the locked condition.

Turning now to FIGS. 2A-2C, a first attachment 16 is shown. This attachment, a nosepiece 60, is suitable for holding and guiding nails of approximately 3½ inches in length during hammering. The nosepiece 60 includes a driver 61, a base 62 fixed on the driver 61, and a guide 63 that slides over the driver 61. When the nosepiece 60 is installed in the hammer 10 and the hammer 10 is operated, the guide 63 quickly slides backward and forward on the driver 61, such that the driver 61 moves between an extended position (FIG. 2B) and a compressed position (FIG. 2C) within the guide 63. Expressed in another way, the guide 63 moves axially between an extended position (FIG. 2B) and a compressed position (FIG. 2c) on the driver 61 when the hammer 10 cycles the nosepiece 60.

The driver 61 is a rigid shaft carried in front of the piston 30 of the hammer 10 where it can be impacted cyclically and moved reciprocally. The driver 61 has a long, cylindrical, constant-diameter shank 64 extending from a front end 65 to a rear end 66. The driver 61 includes an axial flat 68 formed into its outer surface, the flat 68 extending from the front end 65 to a location generally intermediate between the front and rear ends 65 and 66. Just behind the front end 65, a pin 70 is firmly set into a transverse bore in the shank 64 of the driver 61. The pin 70 may be a split pin, slotted pin, or the like, and is just slightly longer than the outer diameter of the shank 64, such that opposed ends 71 of the pin 70 project beyond the outer surface of the shank 64. These ends 71 slide within slots in the guide 63.

Another pin 72 is firmly set into a bore just in front of the rear end 66. This pin 72 also has opposed ends 73 which project beyond the outer diameter of the shank 64. This pin 72 fixes the base 62 on the driver 61. The base 62 is a cylindrical collar fit onto the driver 61 and has varying inner and outer diameters.

The base 62 and part of the driver 61 cooperate to form an engagement portion 67 of the nosepiece 60, which engages with the mount 13 of the hammer 10. The base 62 is a sleeve fit over and fixed to the driver 61, defining the engagement portion 67 and capturing a spring 80. The engagement portion 67 includes the rear end 66 of the driver 61, a rear portion 74, a front portion 75, a flange 76, and a forward end 77. The rear portion 74 is part of the driver 61 extending between the front portion 75 and the rear end 66 of the driver 61. The rear portion 74 has an outer diameter 56, which is the smaller outer diameter of the engagement portion 67, but has the longest axial length. The rear portion 74 extends from the rear end 66 to the front portion 75, where the outer diameter increases. The front portion 75 is formed through with a bore that receives the pin 72. This pin 72 securely fixes the base 62 on the driver 61.

The front portion 75 extends axially forward to the flange 76, at which point the outer diameter increases again to an outer diameter 57. The rear and front portions 74 and 75 of the engagement portion 67 are sized and shaped to fit into the mount 13 of the hammer 10, and the flange 76 is sized to engage with the ball bearings 45 in the inner barrel 41 of the mount 13. The outer diameter 57 of the flange 76 is larger than the outer diameter of the front portion 75 and is larger than the inner diameter 55 defined by the ball bearings 45 when they are disposed within the holes 50 in the inner barrel 41. The forward end 77 is in front of the flange 76 and has a smaller diameter than the flange 76, a diameter which corresponds to that of the front portion 75.

Flanked by the smaller-diameter front portion 75 and forward end 77, the flange 76 thus constitutes an interference with respect to those ball bearings 45. Returning briefly to FIG. 1F, but with continuing reference to the elements identified in FIG. 2B, to apply the nosepiece 60 to the mount 13, the nosepiece 60 is taken up, such as by hand, and the rear end 66 of the driver 61 is directed toward the mount 13. The driver 61 is registered with the interior 35 and the nosepiece 60 is moved backward into the interior 35. The engagement portion 67 enters the interior 35 initially without interference. However, when at rest, the mount 13 is in the unlocked condition, the outer sleeve 40 is forward, and the ball bearings 45 are seated in the holes 50 in the barrel 41 and biased inwardly, and so when the flange 76—which has the larger outer diameter 57 than the inner diameter 55 defined by the ball bearings 45—encounters the ball bearings 45, the ball bearings must be displaced. The worker pulls the outer sleeve 40 backward to register the depressions 44 in the outer sleeve 40 with the holes 50 in the inner barrel 41, and when the flange 76 is moved into and against the ball bearings 45, they are displaced slightly into the depressions 44 to allow the flange 76 past. Once the flange 76 has slipped past the ball bearings 45, the worker releases the outer sleeve 40, which snaps back into its advanced condition, and the inner surface 47 of the outer sleeve 40 pushes the ball bearings 45 back into the holes 50.

Now, the ball bearings 45 are in contact with the forward end 77, and the flange 76 is behind the ball bearings 45. The nosepiece 60 cannot inadvertently come out of the mount 13, because the smaller inner diameter defined by the ball bearings 45 prevents the flange 76 from moving axially forward. Unless the worker moves the mount 13 into the unlocked condition, the nosepiece 60 is secured in the mount 13.

Under the base 62, below the flange 76 and the forward end 77, there is an annular space 78 defined between the inner diameter of the base 62 and the outer diameter of the driver 61. This annular space 78 receives a helical compression spring 80 which is carried over the shank 64 of the driver 61. The spring is compressed between the base 62 and the guide 63 and serves to bias the guide 63 forwardly away from the base 62. The spring 80 is closely fit around the shank 64.

The guide 63 is a sleeve fit over the driver 61; it has a front end 81, a rear end 82, and an elongate cylindrical sidewall 83 extending therebetween. The sidewall 83 bounds and defines an interior which is in open communication with a muzzle or opening. The guide 63 has a front end 81, a rear end 82, and an elongate cylindrical sidewall 83 extending therebetween. The sidewall 83 bounds and defines an interior 84 which is in open communication with a muzzle or opening 85 at the front end 81 and an opening at the rear end 82. The inner diameter of the sidewall 83 is constant along its length between the front and rear ends 81 and 82. It closely receives the shank 64 of the driver 61 when the driver reciprocates within the interior 84.

The front end 65 of the driver 61 is fit within the interior 84. Slots 86 (best shown in FIG. 2A) are formed into the sidewall 83 on opposed sides of the guide 63. The slots 86 extend axially along nearly the entire length of the guide 63, and each receives one of the ends 71 of the pin 70. The pins 70 thus guide reciprocal movement of the driver 61 in the guide 63. The front end 65 of the driver 61 is set into the interior 84, and the slots 86 do not extend fully to the rear end 82 of the guide 63, so that the driver 61 overlaps with the guide 63 and remains within the guide 63 at all times and in all positions of its reciprocating cycle.

The guide 63 will accept and house a fastener 15, preferably a 3½″ nail. Indeed, the guide 63 holds and guides a fastener 15 which is applied thereto in front of the driver 61. The guide 63 has a smooth inner surface, and the inner diameter of the guide 63 corresponds roughly to the size of the head of a 3½″ nail. Of course, other inner diameters are contemplated within the spirit and scope of this disclosure to receive heads of other sizes. Three axially-aligned bores are formed through the sidewall 83 of guide 63; in each of these bores a magnet 87 is applied and fixed, preferably with an epoxy or other adhesive. Two magnets 87 are disposed in the sidewall of the guide 63 proximate the front end 81 and one is proximate the rear end 82. The magnets 87 are directed inward to magnetically attract and loosely hold the fastener after it has been inserted into the interior 84 of the guide 63. The magnets 87 are sufficiently strong to retain the fastener in the interior 84 when the driver 61 is not reciprocating, but are not so strong that the driver 61 cannot move the fastener out of the interior to drive it into a working surface 19. While attraction of the fastener is desired, it is not beneficial to attract the driver 61 while it is reciprocating, as this can cause its cycling to slow down. The flat 68 formed into the outer surface of the shank 64 spaces the metal of the driver 61 sufficiently apart from the magnets 87 that the reciprocation of the driver 61 is not affected by magnetic attraction.

When a fastener 15 is inserted into the guide 63, and the nosepiece 60 is applied to the hammer 10, the hammer 10 can drive the fastener 15. The front end 81 of the guide 63 is formed with several prongs 88. These prongs 88 bite into the working surface 19 during operation of the hammer 10 to steady the hammer 10. Generally, the fastener 15 is muzzle-loaded, head first, through the opening 85, and the tip of the fastener 15 extends slightly past prongs 88. With the driver 61 in the extended position, the fastener 15 is inserted nearly entirely into the guide 63.

The nosepiece 60 not only holds the fastener 15 but guides it during hammering. Briefly, as the hammer 10 operates, the fastener 15 is driven into the working surface 19. As the fastener 15 is driven into the working surface 19, the guide 63 recedes and moves rearwardly over the shank 64 of the driver 61. Thus, the guide 63 moves from the extended position, shown in FIG. 2B, to the compressed position, shown in FIG. 2C. In the extended position, the rear end 82 of the guide 63 is located at the front end 65 of the driver 61. The spring 80 is fully extended around the shank 64 of the driver 61.

At all times, the guide 63 surrounds the fastener 15 above the working surface 19. When the fastener 15 is initially placed within the guide 63, the guide 63 surrounds nearly the entire length of the fastener 15; as can be seen in FIGS. 2B and 2C, with the fastener 15 loaded into the guide 63 and the guide 63 in the extended position thereof, the tip of the fastener 15 extends just beyond the prongs 88 of the guide 63. The worker sets the tip of the fastener 15 in the desired spot on the working surface 19 and then raises the hammer 10 to the desired angle with respect to the working surface 19. The tip of the fastener 15 may push slightly into the working surface 19 and become sunk therein, thereby establishing an anchor point for the hammer 10. The entire length of the fastener 15 above the working surface 19 is within the guide 63, encircled by its sidewall 83.

Once the hammer 10 is readied in this fashion, the worker depresses the trigger 14. Depressing the trigger 14 causes pressurized gas to be cyclically provided and exhausted into and out of the interior 26 of the hammer 10, in front of and behind the piston 30, to cause the piston 30 to reciprocate quickly. The piston 30 repeatedly slams against or impacts the rear end 66 of the driver 61.

FIGS. 1F and 1G show the relative positions of the driver 61 and the piston 30 during hammering. As can be seen first in FIG. 1F, the rear end 66 of the driver 61 extends, in interference, approximately five millimeters into the interior 26 where the piston 30 moves, such that the strokes of the piston 30 and driver 61 overlap by five millimeters. FIG. 1F shows a fully-retraced position on the driver 61. The front portion 75 is in contact with the front of the neck 28, preventing further rearward movement of the driver 61. The rear end 66 of the driver 61 extends beyond the front of the neck 28, through the central bore 53 of the bumper 39, and just past the bumper 39 into the interior 26; the rear end 66 is approximately one millimeter past the bumper 39 in FIG. 1F. FIG. 1F also shows the piston 30 moving axially forwardly in the interior 26. The front end of the piston 30 has just encountered the rear end 66 of the driver 61, but has not fully advanced inside the cylinder 25. As such, there is a slight annular gap between the front end of the piston 30 and the bumper 39.

The front end of the piston 30 encounters and impacts the rear end 66 of the driver. As shown in FIG. 1G, the driver 66 and piston 30 together move axially forward. FIG. 1G illustrates the fully advanced position of the piston 30; the piston 30 encounters the bumper 39 and compresses it slightly, but is prevented by the bumper 39 from further forward axial movement. The driver 61 is not so encumbered, however, and so the driver 61 will continue to move forward until the flange 76 encounters the ball bearings 45. The smaller inner diameter 55 of the ball bearings 45 prevents the flange 76 from moving further axially forward, and with the worker pushing the hammer 10 downward, the fastener 15 pushes the driver 61 back toward the rear end 21 of the hammer 10. This resets the driver position as the piston 30 continues to cycle. As such, the driver 61 again is placed into the retracted position shown in FIG. 1F, and the piston 30 reciprocates to hit and move the driver 61 forward. As the piston 30 repeatedly slams against the rear end 66 of the driver 61, the driver 61 repeatedly hammers the head of the fastener, causing the fastener 15 to drive into the working surface 19. The guide 63 moves more over the driver 61, and the spring 80 compresses as the base 62 moves toward the guide 63.

As the piston 30 continues to cycle and the driver 61 continues to hammer the fastener into the working surface 19, the guide 63 must recede rearwardly on the driver 61. The front end 81 of the guide 63 is pressed against the working surface 19 and this imparts movement along the arrowed line A in FIG. 2B of the guide 63 over the driver 61. As the guide 63 so recedes, the front end of the spring 80 compresses. The rear end of the spring 80 is held in place within the annular space 78 of the base 62. The effective length of the nosepiece 60, between the front end 81 of the guide 63 and the rear end 66 of the driver 61, thus begins to shorten and the nosepiece 60 collapses to accommodate the hammering of the fastener 15.

While the nosepiece 60 collapses, the guide 63 continues to surround the fastener 15 above the working surface 19. Of course, as the hammer operates, it drives the fastener 15 further into the working surface 19 and the fastener moves increasingly from within the guide 63 to below the working surface 19.

As long as the worker continues to hold down the trigger 14, the piston 30 continues to cycle. The worker depresses the trigger 14 preferably until the fastener 15 is fully sunk into the working surface 19. When the fastener 15 is fully sunk, the guide 63 is fully receded into its compressed position, and the front end 65 of the driver 61 is just beyond the prongs 88 of the guide 63. Preferably, the front end 65 extends approximately one millimeter beyond the prongs 88 of the guide 63. When the worker lets off the trigger 14, the piston 30 stop moving, and the worker can draw the hammer 10 off the fastener 15. When that occurs, the spring 80 elongates and pushes the guide 63 forward, back to its extended position.

If the worker is done with the nosepiece 60, it can be removed and a new fastener 15 can be muzzle loaded and driven in the manner described above. To remove the nosepiece 60, the worker grips the outer sleeve 40 and pulls it backward over the inner barrel 41. This registers the depressions 44 over the holes 50. The worker then also grabs the nosepiece 60 and pulls it outward from the hammer 10. When the nosepiece 60 is pulled from the hammer 10, the flange 76 moves forward in the hollow interior 35. The flange 76 pushes the ball bearings 45 radially outward so that they displace into the depressions 44. When the ball bearings 45 are fully seated in the depressions 44, they define an inner diameter which allows the flange 76 to continue to move forward, out of the interior 35. Once the flange 76 has cleared the ball bearings 45, the worker can release the outer sleeve 40. The spring 42 pushes the outer sleeve 40 back to its advanced position, and the mount 13 is returned to a locked condition. The worker may then apply another attachment 16 as described above.

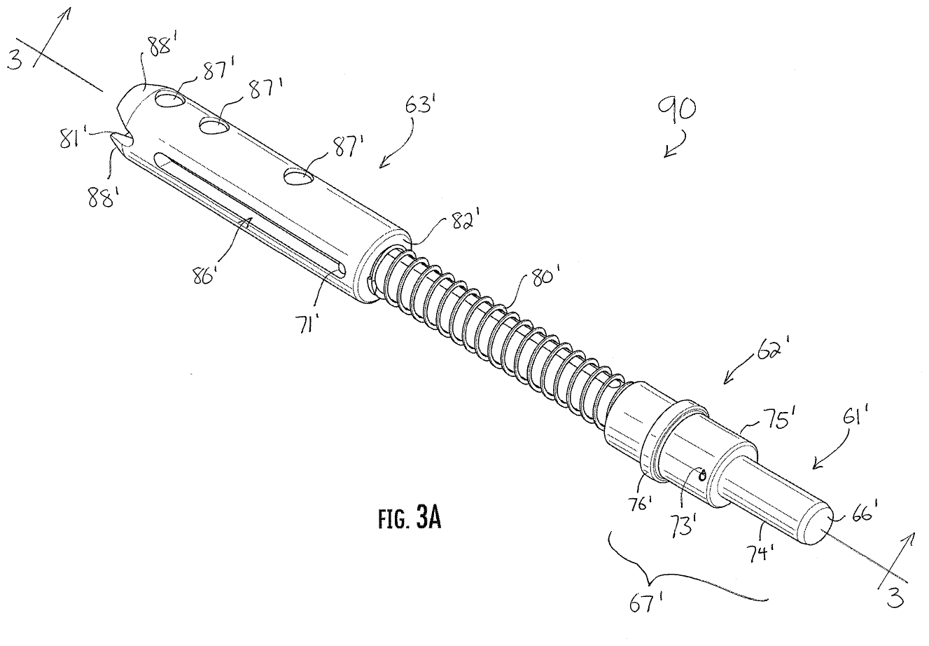

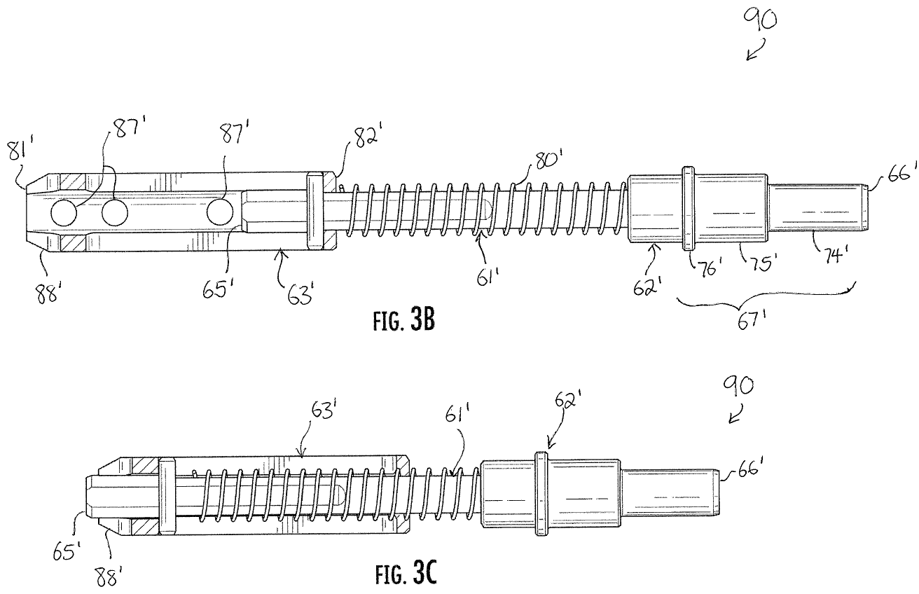

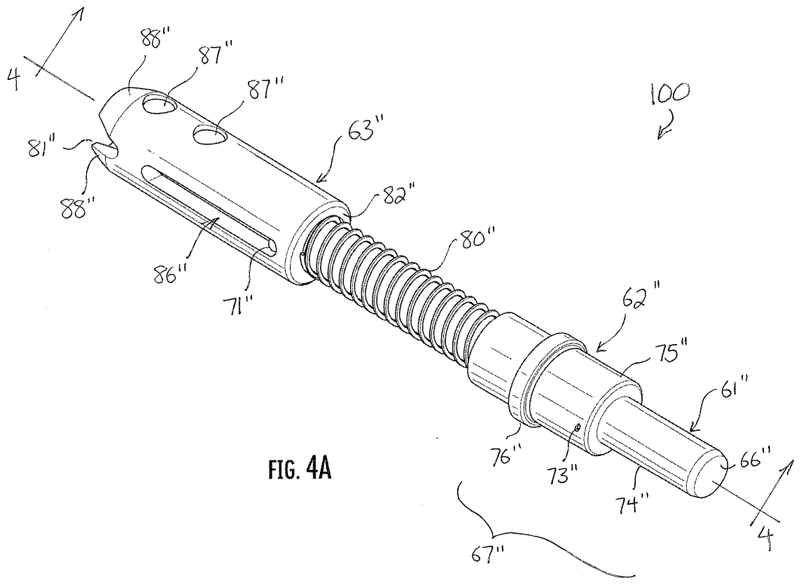

Turning now to FIGS. 3A-3C, another attachment 16 is shown. This attachment, a nosepiece 90, is suitable for driving nails of approximately 2½ inches in length. The nosepiece 90 is nearly identical to the nosepiece 60 but for size. As such, structural elements and features that are common to both nosepieces 60 and 90 are referred to with the same names and reference characters, but those of the nosepiece 90 are marked with a prime (“′”) symbol to distinguish them from those of the nosepiece 60. Further, for those structural elements and features which are identical, no detailed description is presented here, as the structure and function will be understood by the foregoing description. Moreover, the drawings of FIGS. 3A-3C are slightly different than those of FIGS. 2A-2C; they show slightly different views and may use fewer reference characters. These drawings illustrate the nosepiece 60 and the nosepiece 90 in different ways to provide a more robust disclosure of each.

Accordingly, the nosepiece 90 includes a driver 61′, base 62′, and guide 63′. These three constituent elements are identical to the corresponding driver 61, base 62, and guide 63 of the nosepiece 60, but have slightly different proportions. Further, the guide 63 is slightly different at its front end, as will be explained. The nosepiece 90 also includes, at least, shank 64′, front and rear ends 65′ and 66′, engagement portion 67′, flat 68′, pin 70′, ends 71′, pin 72′, ends 73′, rear portion 74′, outer diameter 56′ of the rear portion 74′, front portion 75′, flange 76′, outer diameter 57′ of the flange 76′, forward end 77′, annular space 78′, spring 80′, front end 81′, rear end 82′, sidewall 83′, interior 84′, opening 85′, slot 86′, magnets 87′, and prongs 88′.

As can be seen in the drawings, the nosepiece 90 is slightly shorter than the nosepiece 60. Further, the magnets 87′ are disposed in different locations. While there are still three magnets 87′, the two forward magnets 87′ are further forward on the guide 63 than are the magnets 87 in the nosepiece 60, and the rear magnet 87′ is further from the rear end 82′ than the rear magnet 87 is to the rear end 82. The prongs 88′ also have a different shape than the prongs 88. While the prongs 88 are each fairly slender, separated by wide gaps, the prongs 88′ are wider and separated by smaller gaps.

Operation of the nosepiece 90 is nearly the same as operation of the nosepiece 60. When the trigger 14 of the hammer 10 is depressed, the piston 30 repeatedly slams into the rear end 66′ of the driver 61′, until the guide 63′ is fully retracted over the driver 61′ and the fastener is sunk into the working surface. When the guide 63′ is compressed over the driver 61′, the front end 65′ of the driver 61′ projects out beyond the prongs 88′ of the guide 63′. This ensures that the driver 61′ fully cycles and extends to drive the fastener.

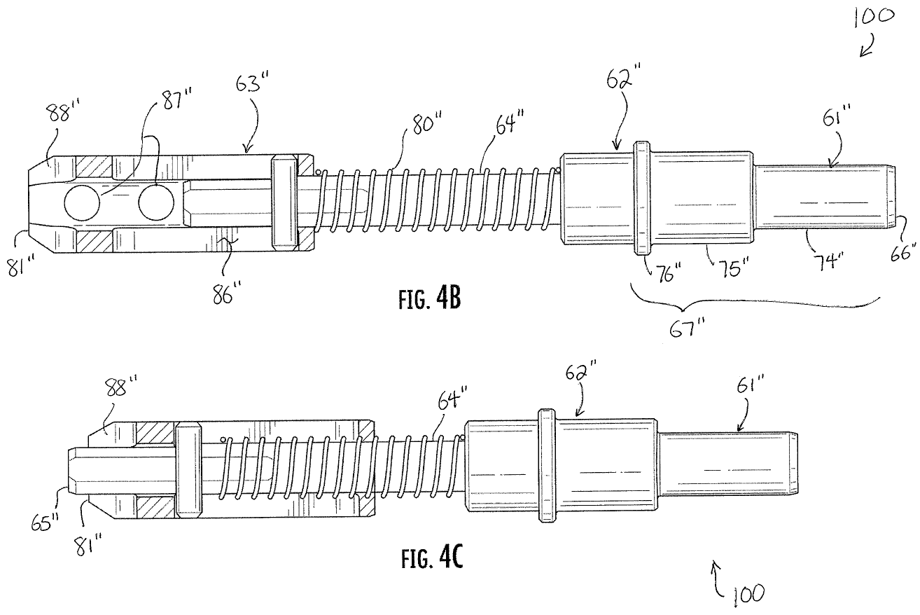

Turning now to FIGS. 4A-4C, another attachment 16 is shown. This attachment, a nosepiece 100, is suitable for driving nails of approximately 1½ inches in length. The nosepiece 100 is nearly identical to the nosepieces 60 and 90 but for size. As such, structural elements and features that are common to both nosepieces 60 and 100 are referred to with the same names and reference characters, but those of the nosepiece 100 are marked with a double-prime (“″”) symbol to distinguish them from those of the nosepiece 60. Further, for those structural elements and features which are identical, no detailed description is presented here, as the structure and function will be understood by the foregoing description. Moreover, the drawings of FIGS. 4A-4C are slightly different than those of FIGS. 2A-2C; they show slightly different views and may use fewer reference characters. These drawings illustrate the nosepiece 60 and the nosepiece 100 in different ways to provide a more robust disclosure of each.

Accordingly, the nosepiece 100 includes a driver 61″, base 62″, and guide 63″. These three constituent elements are identical to the corresponding driver 61, base 62, and guide 63 of the nosepiece 60, but have slightly different proportions. Further, the guide 63 is slightly different at its front end, as will be explained. The nosepiece 100 also includes, at least, a shank 64″, front and rear ends 65″ and 66″, engagement portion 67″, flat 68″, pin 70″, ends 71″, pin 72″, ends 73″, rear portion 74″, outer diameter 56″ of the rear portion 74″, forward portion 75″, flange 76″, outer diameter 57″ of the flange 76″, forward end 77″, annular space 78″, spring 80″, front end 81″, rear end 82″, sidewall 83″, interior 84″, opening 85″, slot 86″, magnets 87″, and prongs 88″.

As can be seen in the drawings, the nosepiece 100 is slightly shorter than the nosepiece 60. Further, the magnets 87″ are different in number and location. While there are three magnets 87 on the nosepiece 60, there are only two magnets 87″ on the nosepiece 100. The two magnets 87″ are disposed proximate the front end 81″ and are closer to the front end 81″ than are the two magnets 87 which are proximate to the front end 81. The nosepiece 100 has not magnet 87 proximate the rear end 82″. The prongs 88″ of the nosepiece 100 have a different shape than the prongs 88, a shape which is identical to the prongs 88′ on the nosepiece 90. While the prongs 88 are each fairly slender, separated by wide gaps, the prongs 88″ are wider and separated by smaller gaps.

Operation of the nosepiece 100 is nearly the same as operation of the nosepiece 60. When the trigger 14 of the hammer 10 is depressed, the piston 30 repeatedly slams into the rear end 66″ of the driver 61″, until the guide 63″ is fully retracted over the driver 61″ and the fastener is sunk into the working surface. When the guide 63″ is compressed over the driver 61″, the front end 65″ of the driver 61″ is flush with the front end 81″ of the of the guide 63″.

Attention is now directed to FIG. 5, which is a perspective view of another attachment, a processing tool 110 useful for scraping working surfaces. The tool 110 has a front end 111, a rear end 112, and a shank 113 extending from the rear end 112 to a scraper 119 processing implement at the front end 111. The tool 110 is one-piece, constructed integrally and monolithically from a material or combination of materials having strong, rigid, rugged, and durable characteristics, such as steel, iron, or like metals.

The shank 113 is generally cylindrical along its length between the front and rear ends 111 and 112, and generally has a constant outer diameter, except as described here. The shank 113 and scraper 119 are formed integrally and monolithically to each other. The front end 111 of the tool 110 is forked: two prongs 114 extend forwardly and are spaced apart by a slot 115. The prongs 114 are blunt and have flat edges 116 aligned transverse to the length of the shank 113. The slot 115 is a V-shaped slot with its narrow end directed toward the rear end 112 of the tool 110 and its wide end open at the front end 111 between the two flat edges 116.

Two long, low, multi-angled bevels 117 and 118 extend rearward from the flat edges 116 of the prongs 114. From the flat edges 116, the bevel 117 is oriented approximately transversely. Just in front of the narrow end of the slot 115, the bevel 117 increases its angle with respect to the flat edges 116, aligning nearly parallel with the length of the shank 113. Then, from a distance approximately twice as large as the length of the slot 115, the bevel 117 changes its angle again, increasing more with respect to the flat edges 116, and extending rearwardly through the shank 113 until it terminates. The bevel 118 has a similar profile on the opposite side of the tool 110. The bevels 117 and 118 allow the prongs 114 and the slot 115 to engage with a working surface at an angle offset from the length of the tool 110. This structure at the front end 111 of the tool 110 is the processing implement and defines the scraper 119: the bevels 117 and 118, the prongs 114, the slot 115, and the flat edges 116. The tool 110 can be slid, scraped, or ground across the working surface to lift material, fasteners, and other elements on the working surface. Moreover, the slot 115 is effective at pulling nails. The shank of a partially-sunk nail is positioned in the slot 115, with the head of the nail against either of the bevels 117 and 118, and positioning the other of the bevels 117 and 118 against the working surface in which the nail is partially-sunk. The tool 110 then can be angled and operated to lift and remove the nail from the working surface.

The processing tool 110 has an engagement portion 120 allowing the tool 110 to be fit into and engaged with the hammer 10. The engagement portion 120 includes a flange 121 formed proximate the rear end 112 and the shank 113 between the flange 121 and the rear end 112. The flange 121 is a radially-outward extension of the shank 113; it has a larger outer diameter than the rest of the shank 113. The flange 121 has a forward-facing annular sloped face 122 and an opposite, rear-facing annular sloped face 123. The rear face 123 has a gentler, longer slope than does the forward face 122. Indeed, the forward face 122 is a tight fillet between the outer cylindrical surface of the shank 113 and the flange 121, while the rear face 123 extends approximately four times further back on the tool 110 from the flange 121 than does the forward face 122 extend forwardly on the tool 110.

The engagement portion 120 also includes the rear end 112, as well as a rear portion 124 of the shank 113 between the flange 121 and the rear end 112. This engagement portion 120 fits into the mount 13 and becomes secured therein. The rear portion 124 has an outer diameter which is smaller than the outer diameter of the flange 121 and is also smaller than the inner diameter 55 defined by the ball bearings 45. The outer diameter of the flange 121 is larger than the inner diameter 55. When the tool 110 is pushed into the mount 13, with its rear end 112 directed toward the hammer 10, and the shank 113 registered with the interior 35 of the mount 13, the outer diameter of the flange 121 contacts and is blocked by the ball bearings 45. The mount 13 is in a locked condition, and so a worker pulls the outer sleeve 40 backward to register the depressions 44 in the outer sleeve 40 with the holes 50 in the inner barrel 41. Then, when the flange 121 is moved into and against the ball bearings 45, they are displaced slightly into the depressions 44 to allow the flange 121 past. Once the flange 121 has slipped past the ball bearings 45, the worker releases the outer sleeve 40, which snaps back into its advanced condition, and the inner surface 47 of the outer sleeve 40 pushes the ball bearings 45 back into the holes 50.

Now, the ball bearings 45 are in contact with the shank 113, and the flange 121 is behind the ball bearings 45. The processing tool 110 cannot inadvertently come out of the mount 13, because the smaller inner diameter defined by the ball bearings 45 prevents the flange 121 from moving axially forward. Unless the worker moves the mount 13 into the unlocked condition, the tool 110 is secured in the mount 13.

Once so secured, the hammer 10 can be taken up by hand and the trigger 14 depressed to cycle the processing tool 110. The piston 30 repeatedly slams against the rear end 112, causing the tool 110 to reciprocate quickly. When the tool 110 is placed against a working surface, such as a concrete slab covered with old wood flooring, the tool 110 works under the flooring, scraping the flooring off the slab.

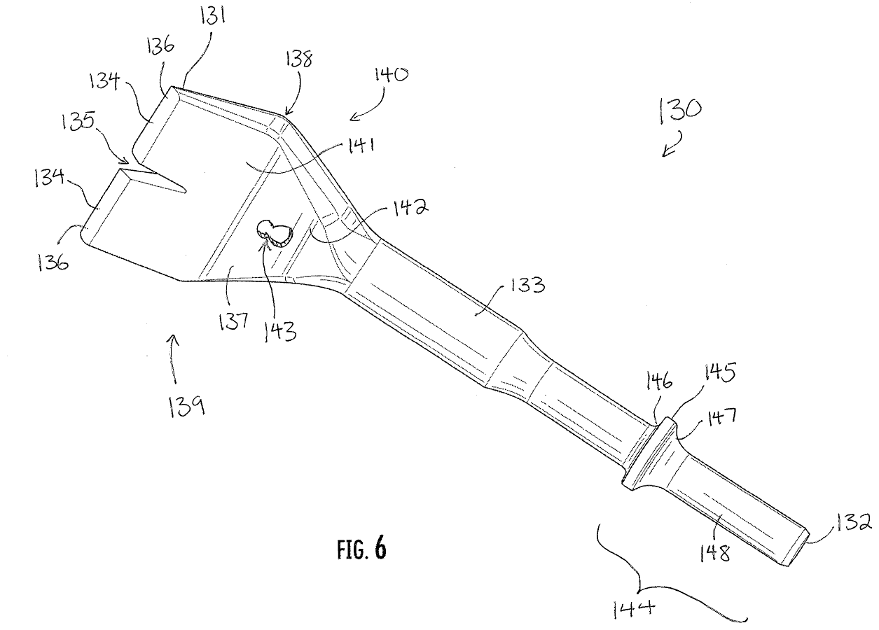

With reference now to FIG. 6, another attachment is shown for use with the hammer: a processing tool 130 useful for scraping working surfaces is shown in perspective view. The tool 130 has a front end 131, a rear end 132, and a shank 133 extending from the rear end 132 to a processing implement at the front end 131 identified as a scraper 139. The tool 130 is one-piece, constructed integrally and monolithically from a material or combination of materials having strong, rigid, rugged, and durable characteristics, such as steel, iron, or like metals.

The shank 133 is generally cylindrical along its length between the front and rear ends 131 and 132. The front end 131 of the tool 130 is wide and is forked: two prongs 134 extend forwardly and are spaced apart by a slot 135. The prongs 134 are wide; each is about three times wider than the prongs 114. The prongs 134 are also blunt and have flat edges 136 aligned transverse to the length of the shank 133. The slot 135 is a V-shaped slot with its narrow end directed toward the rear end 132 of the tool 130 and its wide end open at the front end 131 between the two flat edges 136.

Two long, low, multi-angled bevels 137 and 138 extend rearward from the flat edges 136 of the prongs 134. From the flat edges 136, the bevel 137 is oriented approximately transversely and extends first to a distance approximately twice as large as the length of the slot 135. There, the bevel 137 changes its angle, increasing with respect to the flat edges 136, and extending rearwardly through the shank 133 until it terminates. The bevel 138 has a similar profile on the opposite side of the tool 130, is not visible, but should be understood from the description of the bevels 138, 117, and 118. The bevels 137 and 138 terminate in the same axial location on the tool 130 set back from the front end 131, albeit opposed from each other. The bevels 137 and 138 allow the prongs 134 and the slot 135 to engage with a working surface at an angle offset from the length of the tool 130. This structure at the front end 131 of the tool 130 is the processing implement and defines the scraper 139: the bevels 137 and 138, the prongs 134, the slot 135, and the flat edges 116.

The tool 130 can be slid, scraped, or ground across the working surface to lift material, fasteners, and other elements on the working surface. Moreover, the slot 135 is effective at pulling nails. The shank of a partially-sunk nail is positioned in the slot 135, with the head of the nail against either of the bevels 137 and 138, and positioning the other of the bevels 137 and 138 against the working surface in which the nail is partially-sunk. The tool 130 then can be angled and operated to lift and remove the nail from the working surface.

The prongs 134 are quite wide, so as to define a flat head 140 at the front end 131 of the tool 130. Indeed, the prongs 134 are more correctly defined as parts of the flat head 140 formed by the slot 135. The flat head 140 has a wide face 141 and a smaller triangular face 142. The wide face 141 corresponds to the first angled pitch of the bevel 137, and the triangular face 142 corresponds to the second angled pitch of the bevel 137. There is also a wide face and a triangular face on the opposite side of the tool 110. A slotted hole 143 is formed in the triangular face 142, entirely through the head 140. The slotted hole 143 includes a smaller front bore and a larger rear bore, formed proximate each other and in communication with each other. The slotted hole 143 is useful as a nail-puller; the larger rear bore can be fit over the large head of nail, the tool 130 can be slid backward so that the shank of the nail is disposed in the smaller front bore and the head outside the slotted hole 143, and then the tool 130 can be turned or torqued upwardly, so as to use the shank 133 as a lever arm and pull the nail out of the working surface.

The processing tool 130 has an engagement portion 144 allowing the tool 130 to be fit into and engaged with the hammer 10. The engagement portion 144 includes a flange 145 formed proximate the rear end 132 and the shank 133 between the flange 145 and the rear end 132. The flange 145 is a radially-outward extension of the shank 133; it has a larger outer diameter than much of the shank 133. The flange 145 has a forward-facing annular sloped face 146 and an opposite, rear-facing annular sloped face 147. The rear face 147 has a gentler, longer slope than does the forward face 146. Indeed, the forward face 146 is a tight fillet between the outer cylindrical surface of the shank 133 and the flange 145, while the rear face 147 extends approximately four times further back on the tool 130 from the flange 145 than does the forward face 146 extend forwardly on the tool 130.

The engagement portion 144 also includes the rear end 132 as well as a rear portion 148 of the shank 133 between the flange 145 and the rear end 132. This engagement portion 144 fits into the mount 13 and becomes secured therein. As with the tool 110, the flange 145 of the tool 130 has a larger outer diameter than the inner diameter 55 of the ball bearings 45, while the outer diameter of the rear portion 148 is smaller. When the tool 130 is pushed into the mount 13, with its rear end 132 directed toward the hammer 10, the engagement portion 144 of the tool 130 fits into the mount 13 and engages with the mount 13 in an identical fashion as the engagement portion 120 of the tool 110, as described above. As such, discussion of such engagement is not necessary here.

Once the tool 130 is secured in the mount 13, the hammer 10 can be taken up by hand and the trigger 14 depressed to cycle the processing tool 130. The piston 30 repeatedly slams against the rear end 132, causing the tool 130 to reciprocate quickly. When the tool 130 is placed against a working surface, such as a concrete slab covered with old wood flooring, the tool 130 works under the flooring, scraping the flooring off the slab.

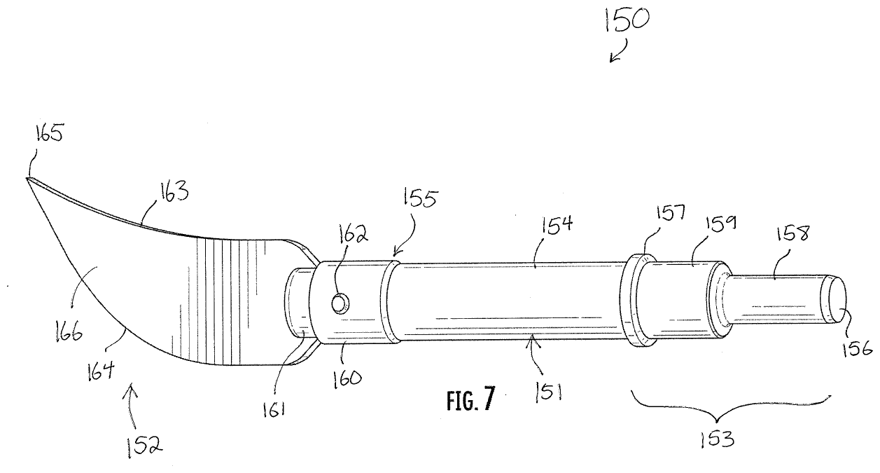

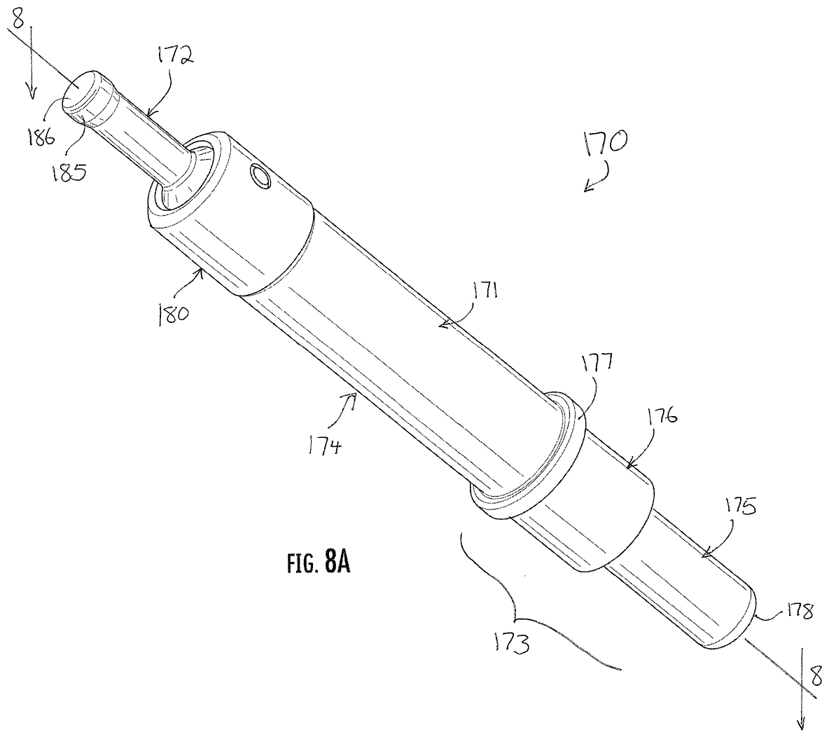

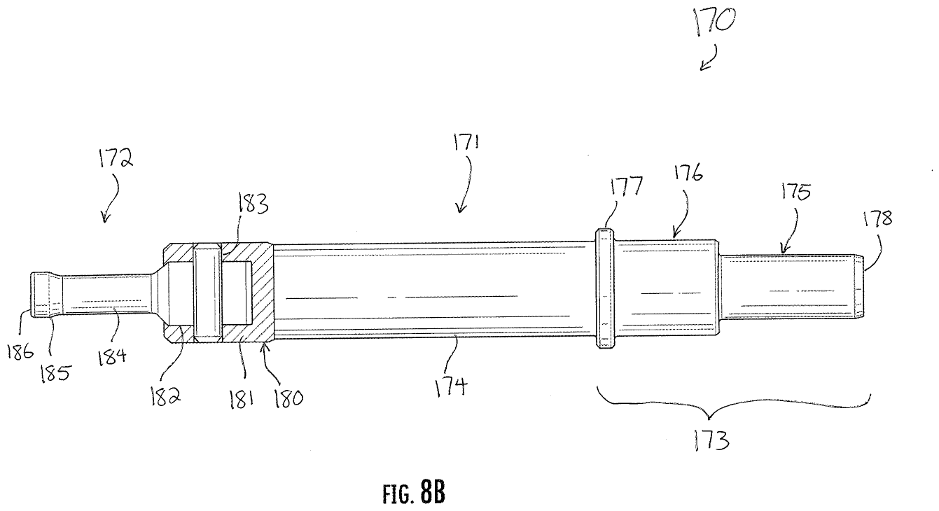

FIG. 7 illustrates another attachment, a processing tool known as a fencing staple remover 150. The remover 150 includes a shank 151 and a processing implement fit into the shank 151. The processing implement is a blade 152 fixed securely into the shank 151 and is useful for slipping under and prying loose fencing staples.

The shank 151 is an elongate cylinder. It includes an engagement portion 153 and a shaft 154 extending forwardly to a chuck 155. In the engagement portion 153, the shank 151 has a rear portion 158 with a first outer diameter, which rear portion 158 extends from a rear end 156 of the shank 151 to a location approximately halfway between the rear end 156 and a flange 157. The shank 151 has a middle portion 159 with a second outer diameter, which middle portion 159 extends from this approximately halfway position forwardly to the flange 157. The second outer diameter is larger than the first outer diameter. The rear and middle portions 158 and 159 of the engagement portion 153 are sized and shaped to fit into the hammer 10 and be received for engagement therein. The engagement portion 153 terminates forwardly with the flange 157. The flange 157 has an outer diameter which is larger than the second outer diameter of the middle portion of the engagement portion 153.

In front of the flange 157, the outer diameter of the shank 151 is the same as the second outer diameter of the middle portion of the engagement portion 153. This outer diameter is constant, and the outer surface of the shank 151 is cylindrical and smooth, until the chuck 155. The chuck 155 includes an outer sleeve 160 which is integrally and monolithically formed as part of the shank 151, but the sleeve 160 is hollow, with an opening at its axial end. A cylindrical base 161 of the blade 152 is fit into the sleeve 160, and a pin 162 through the sleeve 160 and the base 161 secures the base 161 in the sleeve 160.

The blade 152 is formed integrally and monolithically to the cylindrical base 161 as an extension thereof. The blade 152 is planar, extending away from the base 161 as a flat implement. The blade 152 has an inner edge 163 and an opposed outer edge 164. The inner edge 163 is shorter than the outer edge 164 and has a concave shape while the outer edge 164 has a convex shape. The inner and outer edges 163 and 164 meet at a sharp tip 165 of the blade 152. The blade 152 also has opposed sides 166 which are flat, planar, parallel to each other, and meet at the inner and outer edges 163 and 164.

To apply the remover 150 to the hammer 10, it is registered with the interior 35 of the mount 13 and moved into the interior 35. The worker moves the outer sleeve 40 of the mount 13 into the retracted position so that the mount 13 is unlocked and the flange 157 may move past the ball bearings 45. The worker then releases the outer sleeve 40, thereby returning the mount 13 to the locked condition with the remover 150 engaged therein.

In use, the remover 150 is effective at slipping under fencing staples and removing them from a working surface. The sharp tip 165 of the blade 152 can slide under the crown of the staple, and the reciprocal movement of the blade 152 then pries and lifts the staple loose from the working surface.

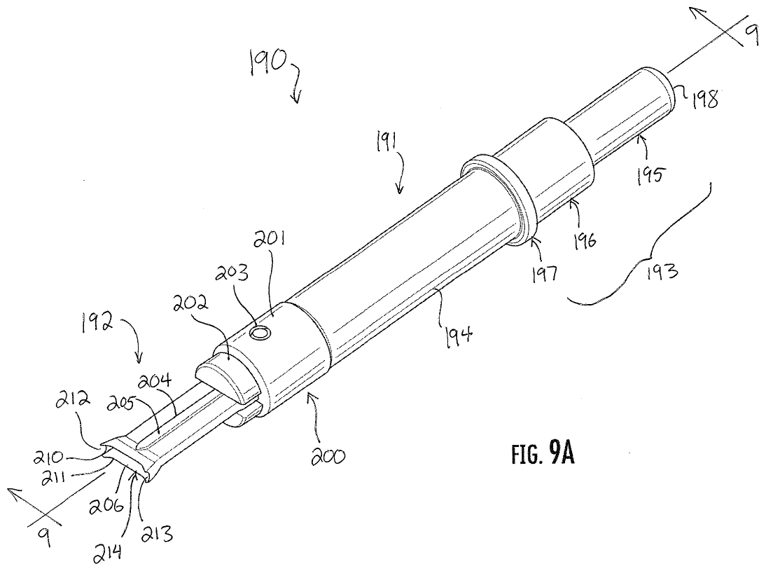

FIGS. 8A and 8B illustrate another attachment or processing tool known as a punch or de-nailer 170. The de-nailer 170 includes a shank 171 and a punch 172 fit into the shank 171. The punch 172 is a processing implement, fixed into the shank 171 securely and useful for punching nails through working surfaces such as planks and other pieces of lumber.

The shank 171 is an elongate cylinder having several different outer diameters. It includes an engagement portion 173 and a shaft 174 extending forwardly to a chuck 180.

The engagement portion 173 includes a rear portion 175, a front portion 176, a flange 177, and a rear end 178 of the shank 171. The rear portion 175 and front portion 176 are of approximately the same axial length, but have different diameters: the rear portion 175 has a smaller diameter than does the front portion 176. The rear portion 175 extends axially from the rear end 178 of the shank 171 to the front portion 176, at which point the diameter of the shank 171 increases. The front portion 176 then extends axially to the flange 177, where the diameter of the shank 171 again increases.

The rear and front portions 175 and 176 of the engagement portion 173 are sized and shaped to fit into the hammer 10, and the flange 177 is sized to engage with the ball bearings 45 within the mount 13. The engagement portion 173 terminates forwardly with the flange 177. The flange 177 has an outer diameter which is larger than the outer diameter of the front portion 176. This flange 177 has a larger outer diameter than the inner diameter 55 of the ball bearings 45, and thus constitutes an interference with respect to the ball bearings 45.

In front of the flange 177, the outer diameter of the shank 171 is the same as the outer diameter of the front portion 176. This outer diameter is constant, and the outer surface of the shank 171 is cylindrical and smooth, until a chuck 180. The chuck 180 includes an outer sleeve 181 which is integrally and monolithically formed as part of the shank 171, but the sleeve 181 is hollow, with an opening at its axial forward end.

The punch 172 has a cylindrical base 182. The base 182 is set into and snugly received in the hollow sleeve 181. A pin 183 locks the base 182 in the sleeve 181; the pin 183 extends through a hole in the sleeve 181, a bore through the base 182, and another hole in the sleeve 181. The pin 183 secures the punch 172 in the shank 171.

The punch 172 is formed integrally and monolithically to the cylindrical base 182 as an extension thereof. The punch 172 is a cylinder of varying diameter. From the base 182, the diameter of the punch 172 decreases slightly along a neck 184. The diameter increases at a head 185 at the front of the punch 172, though the diameter at the head 185 is not as large as the diameter at the base 182. The head 185 terminates with a flat face 186 which is transverse to the length of the punch 172.

To apply the de-nailer 170 to the hammer 10, it is registered with the interior 35 of the mount 13 and moved into the interior 35. The worker moves the outer sleeve 40 of the mount 13 into the retracted position so that the mount 13 is unlocked and the flange 177 may move past the ball bearings 45. The worker then releases the outer sleeve 40, thereby returning the mount 13 to the locked condition with the de-nailer 170 engaged therein.

In use, the de-nailer 170 is effective at punching nails through working surfaces such as planks and other pieces of lumber. Once the de-nailer 170 is set into the hammer 10, the hammer 10 is picked up by hand and the face 186 is placed atop the head of a nail to be driven. The worker depresses the trigger 14 and the hammer operates, causing the de-nailer 170 to reciprocate quickly. When the worker presses the hammer 10 into the nail, the reciprocating de-nailer 170 punches the nail through the working surface until the nail emerges, free, on the other side.

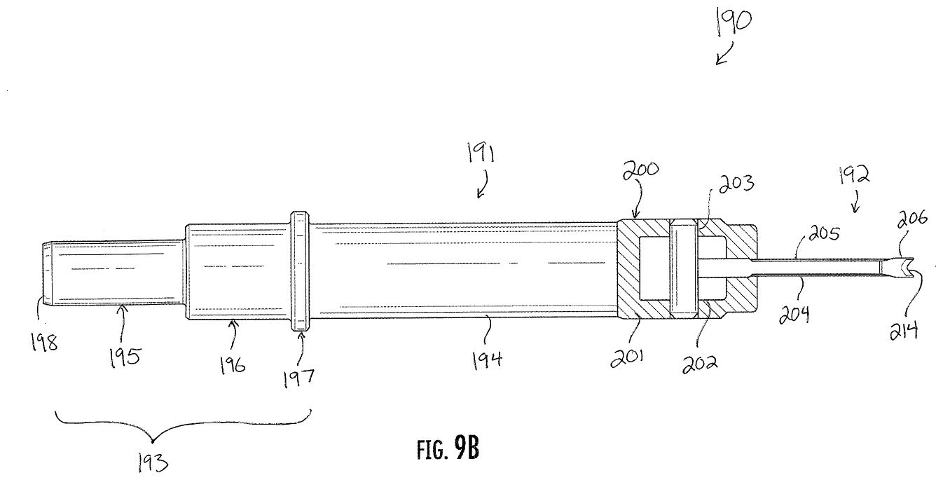

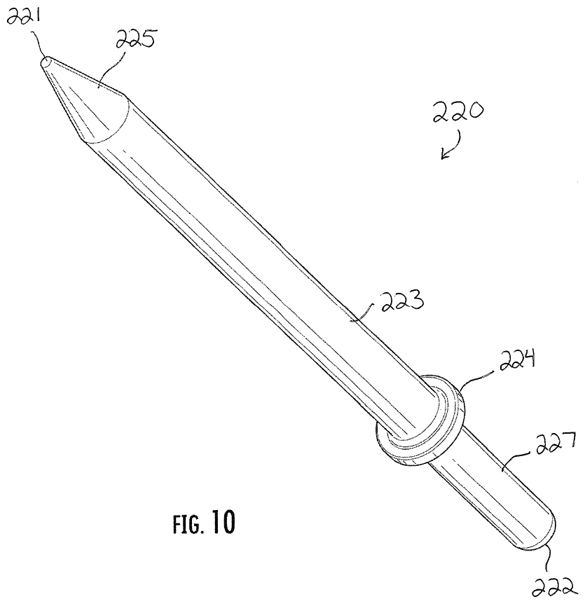

FIGS. 9A and 9B illustrate another attachment or processing tool known as a de-stapler 190. The de-stapler 190 includes a shank 191 and a punch 192 fit into the shank 191. The punch 192 is a processing implement fixed into the shank 191 securely and is useful for punching staples through working surfaces such as planks and other pieces of lumber.

The shank 191 is an elongate cylinder having several different outer diameters. It includes an engagement portion 193 and a shaft 194 extending forwardly to a chuck 200.

The engagement portion 193 includes a rear portion 195, a front portion 196, a flange 197, and a rear end 198 of the shank 191. The rear portion 195 and front portion 196 are of approximately the same axial length but have different diameters: the rear portion 195 has a smaller diameter than does the front portion 196. The rear portion 195 extends axially from the rear end 198 of the shank 191 to the front portion 196, at which point the diameter of the shank 191 increases. The front portion 196 then extends axially to the flange 197, where the diameter of the shank 191 again increases.

The rear and front portions 195 and 196 of the engagement portion 193 are sized and shaped to fit into the hammer 10, and the flange 197 is sized to engage with the ball bearings 45 within the mount 13. The engagement portion 193 terminates forwardly with the flange 197. The flange 197 is a ring formed integrally and monolithically on the shank 191. The flange 197 has an outer diameter which is larger than the outer diameter of the front portion 196. This flange 197 has a larger outer diameter than the inner diameter 55 of the ball bearings 45, and thus constitutes an interference with respect to the ball bearings 45.

In front of the flange 197, the outer diameter of the shank 191 is the same as the outer diameter of the front portion 196. This outer diameter is constant, and the outer surface of the shank 191 is cylindrical and smooth, until a chuck 200. The chuck 200 includes an outer sleeve 201 which is integrally and monolithically formed as part of the shank 191, but the sleeve 201 is hollow, with an opening at its axial forward end.

The punch 192 has a base 202 shaped generally like a cylinder severed hemispherically. The base 202 is set into and snugly received in the hollow sleeve 201. A pin 203 locks the base 202 in the sleeve 201; the pin 203 extends through a hole in the sleeve 201, a bore through the base 202, and another hole in the sleeve 201. The pin 203 secures the punch 192 in the shank 191.

The punch 192 is formed integrally and monolithically to the base 202 as an extension thereof. The punch is a projection having a flat and thin arm 204 extending forwardly from the base 202. The arm 204 has opposed upper and lower major faces, each of which is bifurcated by a stiffening ridge 205 extending axially from the base 202. At the front end of the punch 192 is a saddle 206 size and shaped to receive the crown of a staple. The saddle 206 has opposed long edges 210 and 211 projecting forwardly, parallel to each other. Between the long edges 210 and 211, at the ends thereof, are short edges 212 and 213. Defined between all of these edges 210-213 is a valley or recess 214, into which the crown of the staple is received.

To apply the de-stapler 190 to the hammer 10, it is registered with the interior 35 of the mount 13 and moved into the interior 35. The worker moves the outer sleeve 40 of the mount 13 into the retracted position so that the mount 13 is unlocked and the flange 197 may move past the ball bearings 45. The worker then releases the outer sleeve 40, thereby returning the mount 13 to the locked condition with the de-stapler 190 engaged therein.

In use, the de-stapler 190 is effective at punching staples through working surfaces such as planks, wood-flooring planks, and other pieces of lumber. Once the de-stapler 190 is set into the hammer 10, the hammer 10 is picked up by hand and the saddle 206 is placed atop the crown of a staple to be driven. The worker depresses the trigger 14 and the hammer operates, causing the de-stapler 190 to reciprocate quickly. When the worker presses the hammer 10 into the staple, the reciprocating de-stapler 190 punches the staple through the working surface until the staple emerges, free, on the other side.

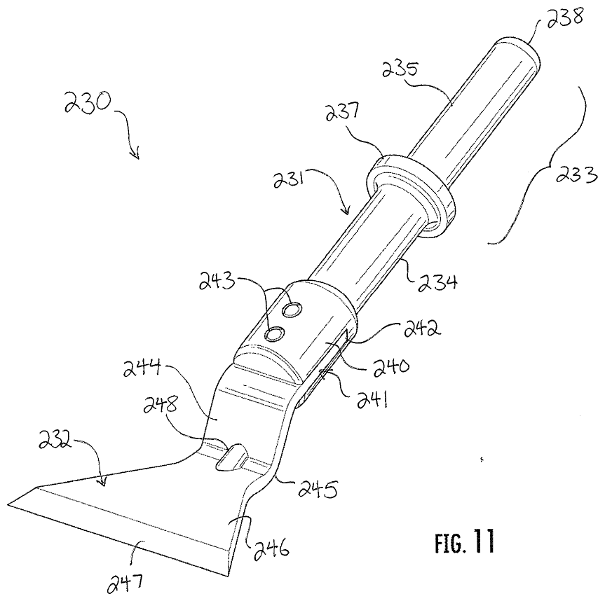

FIG. 10 illustrates another attachment: a conical processing tool 220. The tool 220 includes a front end 221, a rear end 222, and a shank 223 extending from the rear end 222 to a processing implement at the front end 221 of the tool 220. The shank 223 has the same diameter over its entire length, except for a flange 224 proximate the rear end 222 and a tip 225 at the front end 221. The flange 224 is an annular disc projecting radially outward from the shank 223 and thus has an outer diameter which is larger than that of the rest of the shank 223.

At the front end 221, the tip 225 is conical. The diameter of the shank 223 narrows from its diameter along most of its length to a point at the front end 221. The tip 225 is a processing implement of the tool 225 and is useful for boring and breaking a working surface.

The processing tool 220 has an engagement portion allowing the tool 220 to be fit into and engaged with the hammer 10. The engagement portion 226 includes the flange 224, the rear end 222, and a rear portion 227 of the shank 223 between the flange 224 and the rear end 222. This engagement portion 226 fits into the mount 13 and becomes secured therein. The rear portion 227 has an outer diameter which is smaller than the outer diameter of the flange 224 and is also smaller than the inner diameter 55 defined by the ball bearings 45. The outer diameter of the flange 224 is larger than the inner diameter 55.

To apply the tool 220 to the hammer 10, it is registered with the interior 35 of the mount 13 and moved into the interior 35. The worker moves the outer sleeve 40 of the mount 13 into the retracted position so that the mount 13 is unlocked and the flange 224 may move past the ball bearings 45, as described above with respect to other attachments. The worker then releases the outer sleeve 40, thereby returning the mount 13 to the locked condition with the tool 220 engaged therein.

Once the tool 220 is set into the hammer 10, the hammer 10 is picked up by hand and the tip 225 is placed on a working surface. The worker depresses the trigger 14 and the hammer 10 operates, causing the tool 220 to reciprocate quickly. When the worker presses the tool 220 into the working surface, the reciprocating tool 220 punches the surface repeatedly, boring holes and breaking the surface apart.

FIG. 11 illustrates a wide-scraping attachment 230. The attachment 230 includes a shank 231 and a processing implement, identified as a scraper 232, fit into the shank 231. The scraper 232 is fixed into the shank 231 securely and is useful for scraping material from working surfaces.

The shank 231 is an elongate cylinder having several different outer diameters. It includes an engagement portion 233 and a shaft 234 extending forwardly to a chuck 240. The engagement portion 233 includes a rear end 238 of the shank 231, a rear portion 235, and a flange 237. The rear portion 235 extends axially from the rear end 238 of the shank 231 to the flange 237, at which point the diameter of the shank 231 increases. The flange 237 is a ring formed integrally and monolithically on the shank 231. The engagement portion 233 terminates forwardly with the flange 237.

The rear portion 235 of the engagement portion 233 is sized and shaped to fit into the hammer 10, and the flange 237 is sized to engage with the ball bearings 45 within the mount 13. The outer diameter of the flange 237 is larger than the inner diameter 55 of the ball bearings 45 when the mount 13 is locked, but when the flange 237 is pushed into the ball bearings 45 and the mount 13 is unlocked, the ball bearings 45 are displaced. This flange 237 constitutes an interference with respect to the ball bearings 45.

In front of the flange 237, the outer diameter of the shank 231 is slightly larger than the outer diameter of the rear portion 235. This outer diameter is constant, and the outer surface of the shank 231 is cylindrical and smooth, until a chuck 240. The chuck 240 is integrally and monolithically formed as part of the shank 231. The chuck 240 is severed, however, by a slot 241 formed entirely through the chuck between opposed sides thereof, and the slot 241 extending axially into the chuck 240 nearly to the rear end of the chuck 240.

The scraper 232 has a thin, flat base 242. The base 242 is set into and snugly received in the slot 241. Two pins 243 lock the base 242 in the slot 241; each pin 243 extends through a bore in the slot 241, a hole through the base 242, and another bore in the slot 241 on the opposite side of the base 242. The pins 243 secure the scraper 232 in the shank 231.

The scraper 232 is formed integrally and monolithically to the cylindrical base 242 as an extension thereof. Indeed, the scraper 232 is a thin sheet of rigid, strong metal; it is stamped or die-cut and then into the shape of the scraper 232. It includes a neck 244 which extends out from the base 242 and bends downward at an angle away from the plane of the base 242. At a valley or inflection point 245, the neck 244 connects to a head 246 of the scraper 232. An axial ridge 248 in the inflection point 245 increases the strength and rigidity of the inflection point 245. The head 246 is angled oppositely to the neck 244, and as it extends from the neck 244, it widens obliquely to a terminal scraping edge 247. The scraping edge 247 is parallel to the plane of the neck 244.

To apply the attachment 230 to the hammer 10, it is registered with the interior 35 of the mount 13 and moved into the interior 35. The worker moves the outer sleeve 40 of the mount 13 into the retracted position so that the mount 13 is unlocked and the flange 237 may move past the ball bearings 45. The worker then releases the outer sleeve 40, thereby returning the mount 13 to the locked condition with the attachment 230 engaged therein.

In use, the attachment 230 is effective at scraping a working surface. Once the attachment 230 is set into the hammer 10, the hammer 10 is picked up by hand and the scraping edge 247 is placed against the working surface. The worker depresses the trigger 14 and the hammer operates, causing the attachment 230 to reciprocate quickly. When the worker presses the hammer 10 into and along the working surface, the reciprocating attachment 230 scrapes across the working surface to lift material and other elements from the working surface.

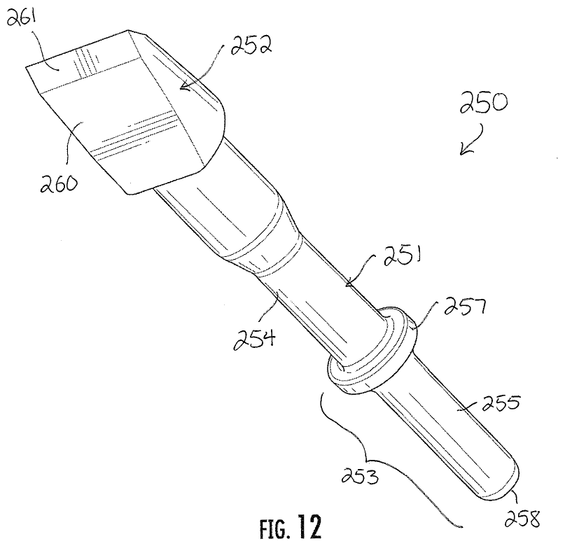

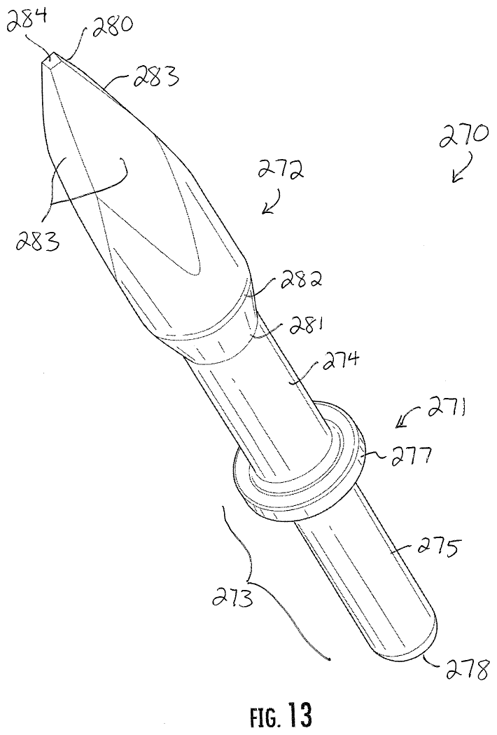

FIG. 12 illustrates another attachment or processing tool: a chiseling tool 250. The tool 250 includes a shank 251 and a processing implement, identified as a chisel 252, fit into the shank 251. The chisel 252 is formed to the shank 251 securely and is useful for chiseling pieces of a working surface.

The shank 251 is an elongate cylinder having several different outer diameters. It includes an engagement portion 253 and a shaft 254 extending forwardly to the chisel 252. The engagement portion 253 includes a rear end 258 of the shank 251, a rear portion 255, and a flange 257. The rear portion 255 extends axially from the rear end 258 of the shank 251 to the flange 257, at which point the diameter of the shank 251 increases. The flange 257 is a ring formed integrally and monolithically on the shank 251.

The rear portion 255 of the engagement portion 253 is sized and shaped to fit into the hammer 10, and the flange 257 is sized to engage with the ball bearings 45 within the mount 13. The engagement portion 253 terminates forwardly with the flange 257. This flange 257 has a larger outer diameter than the inner diameter 55 of the ball bearings 45, and thus constitutes an interference with respect to the ball bearings 45.

In front of the flange 257, the outer diameter of the shank 251 is slightly larger than the outer diameter of the rear portion 255. This outer diameter increases behind the chisel 252, and the outer surface of the shank 251 is cylindrical and smooth. The chisel 252 is integrally and monolithically formed as part of the shank 251. The chisel 252 has opposed convergent faces 260 (one is shown in the drawing) which meet at a chisel edge 261. The chisel 252 is slightly wider than the shank 251, but one having ordinary skill in the art will readily appreciate that the chisel 252 could be narrower or wider in alternate embodiments. Moreover, the chisel edge 261 could have a single-edge grind, a double-edge grind, convex grind, hollow, flat, or sabre grind, bevel grind, compound bevel grind, or some other edge common to chisels and other knife-like instruments.

To apply the tool 250 to the hammer 10, it is registered with the interior 35 of the mount 13 and moved into the interior 35. The worker moves the outer sleeve 40 of the mount 13 into the retracted position so that the mount 13 is unlocked and the flange 257 may move past the ball bearings 45. The worker then releases the outer sleeve 40, thereby returning the mount 13 to the locked condition with the tool 250 engaged therein.

In use, the tool 250 is effective at chiseling out portions of a working surface. Once the tool 250 is set into the hammer 10, the hammer 10 is picked up by hand and the chisel edge 261 is placed against the working surface. The worker depresses the trigger 14 and the hammer operates, causing the tool 250 to reciprocate quickly. When the worker presses the hammer 10 into the working surface at angle, the reciprocating tool 250 will chisel out chunks of the working surface to remove it from the working surface.

FIG. 13 illustrates another attachment for the hammer 10: a chipping tool 270. The tool 270 includes a shank 271 and a processing implement, identified as a chipper 272, fit into the shank 271. The chipper 272 is formed to the shank 271 securely and is useful for chipping large chunks of material from a working surface.

The shank 271 is an elongate cylinder having a few different outer diameters. It includes an engagement portion 273 and a shaft 274 extending forwardly to the chipper 272. The engagement portion 273 includes a rear end 278 of the shank 271, a rear portion 275, and a flange 277. The rear portion 275 extends axially from the rear end 278 to the flange 277, at which point the diameter of the shank 271 increases. The flange 277 is a ring formed integrally and monolithically on the shank 271.

The rear portion 275 of the engagement portion 273 is sized and shaped to fit into the hammer 10, and the flange 277 is sized to engage with the ball bearings 45 within the mount 13. The engagement portion 273 terminates forwardly with the flange 277. This flange 277 has a larger outer diameter than the inner diameter 55 of the ball bearings 45, and thus constitutes an interference with respect to the ball bearings 45.

In front of the flange 277, the outer diameter of the shank 271 is slightly larger than the outer diameter of the rear portion 275. From the flange 277 forward to the chipper 272, the shaft 274 has a constant outer diameter and a smooth, cylindrical outer surface. The chipper 272 is integrally and monolithically formed as part of the shank 271. The chipper 272 has a front end 280, an opposed rear end 281, and a middle band 282 therebetween. The rear end 281 is formed to the shank 271. From the rear end 281 to the middle band 282, the outer diameter of the tool 270 expands gradually and constantly, and maintains a circular cross-section. At the middle band 282, the outer diameter of the tool 270 is at its largest. From the middle band 282 forward, the chipper 272 narrows slightly, until four oblique faces 283 form bevels into the front of the chipper 272. These bevels are oriented axially, and are each arranged transverse with respect to their neighbor, such that they converge to a small square point 284 at the front end 280 of the chipper 272.

To apply the tool 270 to the hammer 10, it is registered with the interior 35 of the mount 13 and moved into the interior 35. The worker moves the outer sleeve 40 of the mount 13 into the retracted position so that the mount 13 is unlocked and the flange 277 may move past the ball bearings 45. The worker then releases the outer sleeve 40, thereby returning the mount 13 to the locked condition with the tool 270 engaged therein.

In use, the tool 270 is effective at chipping out portions of a working surface. Once the tool 270 is set into the hammer 10, the hammer 10 is picked up by hand and the point 284 is placed against the working surface. The worker depresses the trigger 14 and the hammer operates, causing the tool 270 to reciprocate quickly. When the worker presses the hammer 10 into the working surface at angle, the reciprocating tool 270 will chipper out chunks of the working surface to remove it from the working surface.

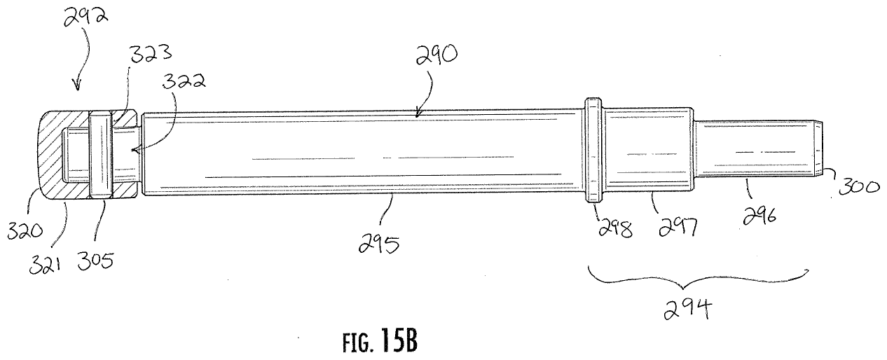

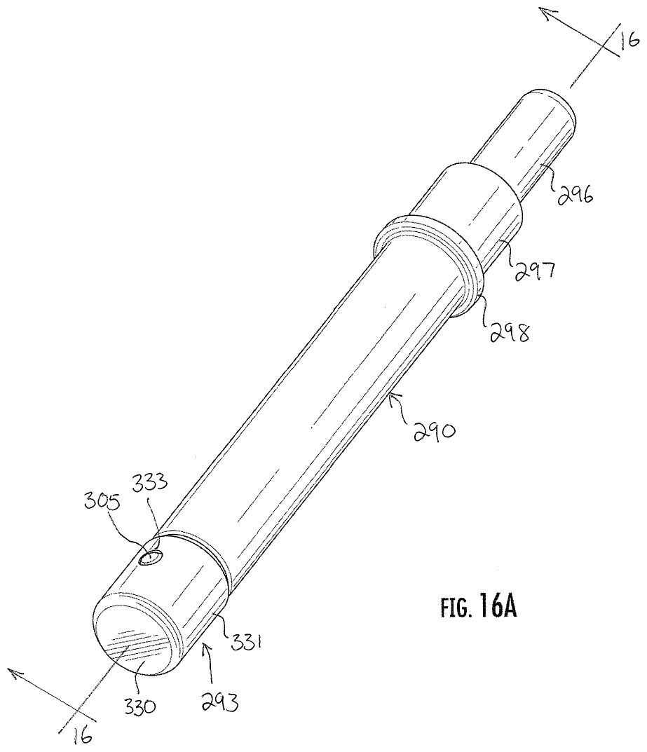

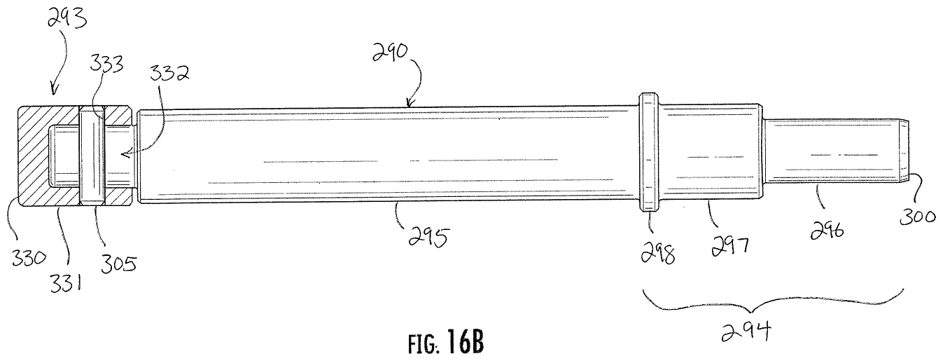

FIGS. 14A-16B show three different attachments for hammering. Each has a different type of processing implement fit on the same shank 290. FIGS. 14A and 14B illustrate a soft hammer head 291 on the shank 290, FIGS. 15A and 15B illustrate a convex hammer head 292 on the shank 290, and FIGS. 16A and 16B illustrate a flat hammer head 293 on the shank 290.

With reference to FIGS. 14A and 14B, the shank 290 is an elongate cylinder having a few different outer diameters. It includes an engagement portion 294 and a shaft 295 extending to the soft hammer head 291. The engagement portion 294 includes a rear end 300 of the shank 290, a rear portion 296, a front portion 297, and a flange 298. The rear portion 296 and front portion 297 are of approximately the same axial length, but have different diameter; the rear portion 296 has a smaller diameter than does the front portion 297. The rear portion 296 extends axially from the rear end 300 of the shank 290 to the front portion 297, where the diameter of the shank 290 increases. The front portion 297 then extends axially to the flange 298, where the diameter of the shank 290 again increases.

The rear and front portions 296 and 297 of the engagement portion 294 are sized and shaped to fit into the hammer 10, and the flange 298 is sized to engage with the ball bearings 45 within the mount 13. The engagement portion 294 terminates forwardly with the flange 298. The flange 298 is a ring formed integrally and monolithically on the shank 290. The flange 298 has an outer diameter which is larger than the outer diameter of the front portion 297. This flange 298 has a larger outer diameter than the inner diameter 55 of the ball bearings 45, and thus constitutes an interference with respect to the ball bearings 45.

In front of the flange 298, the outer diameter of the shank 290 is the same as the outer diameter of the front portion 297. This outer diameter is constant, and the outer surface of the shank 290 is cylindrical and smooth, until a post 302 at a front end 301 of the shank 290.

The post 302 is a reduced-diameter, co-axial projection of the shank 290. It is formed integrally and monolithically as part of the shank 290, and it projects out from the shank 290 to the front end 301 thereof. The post 302 projects forwardly to a flat face 303, transverse to the length of the shank 290. A bore 304 is formed parallel to this face 303, through the post 302. This bore 304 receives a pin 305 that binds the soft hammer head 291 to the post 302.

The soft hammer head 291 is a cup fit over the post 302. It is constructed from a material or combination of materials having soft, elastomeric, resilient qualities, such as rubber or soft plastic. It has a front face 310 and a sidewall 311 extending rearwardly therefrom. The front face 310 is slightly convex, forming a slight outward curve or bow extending forward. The front face 310 has a small rounded corner transitioning to the sidewall 311. The sidewall 311 extends rearwardly nearly to the shank 290. The sidewall 311 is cylindrical, defining an open socket 312 bound by the sidewall 311. When the soft hammer head 291 is fit onto the post 302, the socket 312 is snugly received on the post 302. The pin 305 is passed through opposed holes 313 in the sidewall 311 to securely engage the soft hammer head 291 on the post 302. A small gap 314 is formed between the flat face 303 of the post 302 and the inner surface of the socket 312, just behind the front face 310. While the material of the soft hammer head 291 can be deformed, this gap 314 provides additional deformation to the soft hammer head 291 when it impacts a working surface, fastener, or other element that the hammer 10 is hammering the head 291 against.

Turning to FIGS. 15A and 15B, the convex hammer head 292 is a cup fit over the post 302. It is constructed from a material or combination of materials having hard, durable, rugged, rigid qualities, such as steel, iron, or other like metals. It has a front face 320 and a sidewall 321 extending rearwardly therefrom. Like the front face 310, the front face 320 is slightly convex, forming a slight outward curve or bow extending forward. The front face 320 has a small rounded corner transitioning to the sidewall 321. The sidewall 321 extends rearwardly nearly to the shank 290. The sidewall 321 is cylindrical, defining an open socket 322 bound by the sidewall 321. When the convex hammer head 292 is fit onto the post 302, the socket 322 is fully and snugly received on the post 302. The pin 305 is passed through opposed holes 323 in the sidewall 321 to securely engage the convex hammer head 292 on the post 302. The head 292 is hard, and is useful for pounding nails, staples, and other fasteners into a working surface.

FIGS. 16A and 16B show the flat hammer head 293, which is a cup fit over the post 302. It is constructed from a material or combination of materials having hard, durable, rugged, rigid qualities, such as steel, iron, or other like metals. It has a front face 330 and a sidewall 331 extending rearwardly therefrom. The front face 330 is flat, transverse to the length of the shank 290. The front face 330 has a small rounded corner transitioning to the sidewall 331. The sidewall 331 extends rearwardly nearly to the shank 290. The sidewall 331 is cylindrical, defining an open socket 332 bound by the sidewall 331. When the flat hammer head 293 is fit onto the post 302, the socket 332 is fully and snugly received on the post 302. The pin 305 is passed through opposed holes 333 in the sidewall 331 to securely engage the flat hammer head 293 on the post 302. The head 293 is hard, and is useful for pounding nails, staples, and other fasteners into a working surface.

The shank 290, fit with any of the heads 291, 292, or 293, is applied to the hammer 10 for use. To apply the shank 290 to the hammer 10, it is registered with the interior 35 of the mount 13 and moved into the interior 35. The worker moves the outer sleeve 40 of the mount 13 into the retracted position so that the mount 13 is unlocked and the flange 298 may move past the ball bearings 45. The worker then releases the outer sleeve 40, thereby returning the mount 13 to the locked condition with the shank 290 engaged therein.

A preferred embodiment is fully and clearly described above so as to enable one having skill in the art to understand, make, and use the same. Those skilled in the art will recognize that modifications may be made to the description above without departing from the spirit of the specification, and that some embodiments include only those elements and features described, or a subset thereof. To the extent that modifications do not depart from the spirit of the specification, they are intended to be included within the scope thereof.

What is claimed is:

1. A multi-stroke powered safety hammer system comprising:
a hammer including a body having opposed front and rear ends, a cylinder within the body, and a piston carried in the cylinder for reciprocal movement between the front and rear ends;
a quick-connect coupling mount on the hammer, the mount including an inner barrel bounding a hollow interior coaxial to the piston, an outer sleeve for sliding movement over the inner barrel, and an engagement assembly defined by the inner barrel and the outer sleeve for locking an attachment in the hollow interior; and
an attachment, the attachment including an engagement portion, such that when the engagement portion is applied to the quick-connect coupling mount and the hammer is operated, the piston reciprocates to impact the engagement portion;
wherein the attachment is for holding and guiding fasteners during operation of the hammer.

2. The multi-stroke powered safety hammer system of claim 1, further comprising a bumper in the cylinder, the bumper disposed in front of the piston between the piston and the cylinder.

3. The multi-stroke powered safety hammer system of claim 2, wherein the bumper has a central bore coaxial to the piston and to the hollow interior of the quick-connect coupling mount.

4. The multi-stroke powered safety hammer system of claim 1, wherein, when the hammer is operated, the piston reciprocates in the cylinder in response to the cyclical provision and exhaust of a gas in front of and behind the piston.

5. The multi-stroke powered safety hammer system of claim 1, wherein the attachment includes:
a driver, a base, and a guide, wherein the driver and base cooperate to form the engagement portion applicable to the quick-connect coupling mount; and
the guide is a sleeve fit over the driver to hold a fastener applied therein in front of the driver, the guide so fit for axial movement on the driver.

6. The multi-stroke powered safety hammer system of claim 5, wherein the engagement portion includes:
a rear end of the driver;
a flange on the base having an outer diameter;
a rear portion of the driver extending between the flange and the rear end, the rear portion having an outer diameter less than the flange; and
the outer diameter of the flange is more than an inner diameter within the mount.

7. The multi-stroke powered safety hammer system of claim 5, wherein a magnet is located in a sidewall of the guide to retain a fastener applied to the guide therein.

8. The multi-stroke powered safety hammer system of claim 5, wherein the guide recedes backward over the driver when the hammer is operated to drive a fastener.

9. The multi-stroke powered safety hammer system of claim 5, wherein, when a fastener is applied to the attachment for driving into a working surface, the guide surrounds the fastener above the working surface during operation of the hammer.

10. The multi-stroke powered safety hammer system of claim 1, wherein the engagement assembly comprises:
holes formed in the inner barrel, and ball bearings carried in the holes;
an inner surface of the outer sleeve, and depressions formed into the outer sleeve from the inner surface;
a locked condition of the mount, in which the depressions are offset from the holes, and the inner surface of the outer sleeves urges the ball bearings toward the hollow interior; and
an unlocked condition of the mount, in which the depressions are registered with the holes, and the ball bearings are free to move into the depressions.

11. The multi-stroke powered safety hammer system of claim 10, wherein:
in the locked condition, the outer sleeve is in an advanced position with respect to the inner barrel;
in the unlocked condition, the outer sleeve is in a retracted position with respect to the inner barrel; and
a spring disposed between the inner barrel and the outer sleeve biases the outer sleeve into the advanced position.

12. A multi-stroke powered safety hammer system comprising:
a hammer including a body having opposed front and rear ends, a cylinder within the body defining an interior in which a piston is carried for reciprocal movement between the front and rear ends in response to the cyclical application of a gas into the interior on opposed sides of the piston;
a bumper carried in the cylinder and disposed in front of the piston between the piston and the cylinder;
a quick-connect coupling mount secured on the cylinder at the front end of the body, the mount including an inner barrel bounding a hollow interior, an outer sleeve over the inner barrel, and an engagement assembly defined by the inner barrel and the outer sleeve for locking an attachment in the hollow interior; and
an attachment, the attachment including an engagement portion, such that when the engagement portion is applied to the quick-connect coupling mount and the hammer is operated, the piston reciprocates to impact the engagement portion.

13. The multi-stroke powered safety hammer system of claim 12, wherein the bumper has a central bore coaxial to the piston and to the hollow interior of the quick-connect coupling mount.

14. The multi-stroke powered safety hammer system of claim 12, wherein the attachment includes a shank terminating in a processing implement including one of a scraper, a blade, a punch, a conical tip, a chisel, and a chipper.

15. The multi-stroke powered safety hammer system of claim 12, wherein the attachment includes a shank and a hammer head fixed on the shank.

16. The multi-stroke powered safety hammer system of claim 12, wherein the engagement assembly comprises:
holes formed in the inner barrel, and ball bearings carried in the holes;
an inner surface of the outer sleeve, and depressions formed into the outer sleeve from the inner surface;
a locked condition of the mount, in which the depressions are offset from the holes, and the inner surface of the outer sleeves urges the ball bearings toward the hollow interior; and
an unlocked condition of the mount, in which the depressions are registered with the holes, and the ball bearings are free to move into the depressions.

17. The multi-stroke powered safety hammer system of claim 16, wherein the engagement portion includes:
a rear end of the attachment;
a flange on the attachment having an outer diameter;
a rear portion of the attachment extending between the flange and the rear end, the rear portion having an outer diameter less than the flange; and
the outer diameter of the flange is more than an inner diameter defined by the ball bearings.

18. A multi-stroke powered safety hammer system comprising:
a hammer including a body having opposed front and rear ends, a cylinder within the body defining an interior in which a piston is carried for reciprocal movement between the front and rear ends in response to the cyclical application of a gas into the interior on opposed sides of the piston;
a bumper carried in the cylinder and disposed in front of the piston between the piston and the cylinder; and
a quick-connect coupling mount secured on the cylinder at the front end of the body, the mount including an inner barrel bounding a hollow interior, an outer sleeve over the inner barrel, and an engagement assembly defined by the inner barrel and the outer sleeve for locking an attachment in the hollow interior.

19. The multi-stroke powered safety hammer system of claim 18, further comprising an attachment for holding and guiding fasteners during operation of the hammer, the attachment comprising:
a driver, a base, and a guide, wherein the driver and base cooperate to form the engagement portion applicable to the quick-connect coupling mount; and
the guide is a sleeve fit over the driver to hold a fastener applied therein in front of the driver, the guide so fit for axial movement on the driver.

20. The multi-stroke powered safety hammer system of claim 19, wherein the engagement portion includes:
a rear end of the driver;
a flange on the base having an outer diameter;
a rear portion of the driver extending between the flange and the rear end, the rear portion having an outer diameter less than the flange; and
the outer diameter of the flange is more than an inner diameter within the mount.

21. The multi-stroke powered safety hammer system of claim 18, further comprising an attachment for processing a working surface, the attachment comprising a shank terminating in a processing implement including one of a scraper, a blade, a punch, a conical tip, a chisel; and a chipper.
